(19) United States
(12) Patent Application Publication
(10) Pub. No.: US 2025/0245005 A1
(43) Pub. Date: Jul. 31, 2025

(54) SIGNAL PROCESSING APPARATUS AND METHOD

(71) Applicant: NEC Corporation, Tokyo (JP)

(72) Inventor: Atsufumi SHIBAYAMA, Tokyo (JP)

(73) Assignee: NEC Corporation, Tokyo (JP)

(21) Appl. No.: 19/023,929

(22) Filed: Jan. 16, 2025

(30) Foreign Application Priority Data
Jan. 26, 2024 (JP) 2024-010331

(51) Int. Cl. G06F 9/30; G06F 7/48

(52) U.S. Cl. CPC G06F 9/30025; G06F 9/3001; G06F 7/4824

(57) ABSTRACT

A signal processing apparatus includes an operation processing part to perform operation processing on D-bits data (D is a positive integer greater than or equal to three) represented in a two's complement representation and a storage processing part to perform storage processing on D-bits data represented in a second representation format, wherein the second representation format for a non-negative value of the D-bits data is identical to the two's complement representation and the second representation format for a negative value of the D-bits data has a representation format in which (D−N−1) bits of the D-bits data in the two's complement representation are bit-wise inverted (N is a positive integer such that N≤D−2), the (D−N−1) bits being remaining bits obtained by excluding a most significant bit indicating a sign and N consecutive lower bits including a least significant bit.

### REFERENCE TO RELATED APPLICATION

The present disclosure is based upon and claims the benefit of the priority of Japanese patent application No. 2024-010331 filed on Jan. 26, 2024, the disclosure of which is incorporated herein in its entirety by reference thereto.

### FIELD

The present disclosure relates to a signal processing apparatus and method.

### BACKGROUND

Fast Fourier transform (abbreviated as “FFT”) processing is one of important processing techniques in digital signal processing. For example, frequency domain equalization (FDE) is known as a technique that compensates for waveform distortion during signal transmission in wireless or wired communication.

In the frequency domain equalization, time domain signal data is first transformed to frequency domain data by fast Fourier transform. Next, a filtering process for equalization is performed. Then, the filtered data is transformed back to time domain signal data by inverse fast Fourier transform (abbreviated as “IFFT”). By the above process, a waveform distortion of an original time domain signal is compensated. Hereinafter, when FFT and IFFT are not distinguished, they will be denoted by “FFT/IFFT.”

In general, a “butterfly operation” is used in FFT/IFFT processing. For example, Reference Literature 1 discloses an FFT apparatus using a butterfly operation. Reference Literature 1 also describes “twiddle factor multiplication” (described later), i.e., multiplication using a twiddle coefficient or twiddle factor.

For instance, Reference Literature 2 describes a Cooley-Tukey butterfly operation as an efficient FFT/IFFT processing method. The Cooley-Tukey FFT/IFFT with a large number of points, however, requires a complex circuit. Hence, FFT/IFFT processing is decomposed into two smaller FFTs/IFFTs by using a Prime Factor method described in Reference Literature 3, for example.

FIG. 18 illustrates data flow 500 of a 64-point FFT decomposed into a two-stage radix-8 butterfly process by using the Prime Factor method. The data flow 500 includes a data reordering processing part 501, radix-8 butterfly operations performed a total of sixteen times by butterfly operation processing parts 502 and 503, and a twiddle factor multiplication processing part 504 that multiplies a twiddle factor {Wk} (W=exp(−2πj/N), j²=−1) (twiddle factors are (W0, W1, . . . , W7), . . . (W0, W7, . . . , W49) in FIG. 18).

In the data flow 500 illustrated in FIG. 18, input time-domain data x(n) (n=0, 1, . . . , 63) is Fourier-transformed to frequency-domain signals X(k) (k=0, 1, . . . , 63) by the FFT processing. Note that in FIG. 18, a part of the data flow is omitted. Even when performing IFFT processing, a basic structure of the data flow is the same as the data flow 500 illustrated in FIG. 18.

In a case where the number of FFT points is large, if the entirety of the data flow 500 illustrated in FIG. 18 is to be implemented by a circuit, the circuit will become a huge scale. Therefore, the entirety of the FFT processing is generally implemented by repeatedly utilizing a circuit that implements a partial processing of a data flow according to a required processing performance, in the case where the number of FFT points is large.

For example, in the data flow in FIG. 18, if an FFT apparatus that performs FFT processing on eight pieces of data in parallel (referred to as “in 8-data parallel”, for short) is made as a physical circuit, 64-point FFT processing can be implemented by repeating the processing eight times in total.

Processing repeated eight times is performed sequentially, each corresponding to each of partial data flows 505a to 505h performed on eight pieces of data. More specifically, the processing is performed as follows:
at the first time, the processing corresponding to the partial data flow 505a is performed,
at the second time, the processing corresponding to the partial data flow 505b is performed,
at the third time, the processing corresponding to the partial data flow 505c (not shown in the drawing) is performed.
   Similarly, each of the processing up to the eighth partial data flow 505h is sequentially performed thereafter. The 64-point FFT processing is realized by the processing described above.

In a butterfly operation, a plurality of items of data arranged in a sequential order are read in an order according to a predetermined rule and processed. Therefore, in a butterfly operation, reordering of a plurality of items of data is needed, for which a RAM (Random Access Memory) circuit(s) are mainly used. For example, Reference Literature 4 discloses an FFT apparatus that performs reordering of a plurality of items of data using a RAM circuit(s) for a butterfly operation.

As a low-power consumption technology, for instance, Patent Literature 1 discloses a configuration that includes an operation processing part that performs operation processing such as a butterfly operation on data represented in a two's complement representation and a storage processing part, such as a RAM (Random Access Memory) circuit(s), that perform storage processing on data represented in “sign magnitude-representation,” which is a second representation format as a data representation format, wherein, in the “sign magnitude-representation,” a data value is identical to one in the two's complement representation when the value is positive or zero, and all bits lower than the most significant bit indicating a sign in the two's complement representation are bit-wise inverted when the data value is negative.
[PTL 1]
International Publication Number WO2019/131754 (Page 7, FIG. 1)

### SUMMARY

The two's complement representation is widely used as a method for representing signal data with binary numbers in digital signal processing. In the two's complement representation, an addition/subtraction processing circuit can be realized with a small circuit scale because subtraction can be represented by addition.

On the other hand, a value per bit greatly differ between a small positive value and a small negative value in a vicinity of a value zero in the two's complement representation. As a result, if a signal taking a value which frequently changes between positive and negative in a vicinity of zero is to be represented by a two's complement, a bit-wise operation rate (toggle rate) would become large. Dynamic power consumption (dynamic power) P of a digital signal processing circuit realized by a CMOS (Complementary Metal Oxide Semiconductor) circuit can be expressed by the following Equation (1):

$$P = ( 1 / 2 ) * a * C * V 2 * f \qquad ( 1 )$$

where
a: circuit operation rate (percentage-activity),
C: load capacity,
V: voltage, and
f: operating frequency.

A circuit operation rate (percentage-activity) is a ratio between an estimated value of the number of switching and the number of clock cycles during a certain period of time.

Since a bit-wise operation rate (toggle rate) of signal data determines the percentage-activity a, reducing the bit-wise operation rate is effective in reducing power consumption. Signal data in signal processing for communication often changes between positive and negative in the vicinity of a value zero. In a fast Fourier transform (FFT) which is one of important processes in digital signal processing, internal data often takes a small value near a value zero.

When the two's complement representation is used in these processes, the bit-wise operation rate may become large, resulting in an increased power consumption. In the two's complement representation, of 2\hat{ }n values (\hat{ } is a power operator) that can be expressed as an n-digit binary number, “000 . . . 0” to “011 . . . 1” are assigned to the value 0 and positive values, and the remaining half, “100 . . . 0” to “111 . . . 1,” are assigned to negative values. As an example of the two's complement representation, FIG. 19 shows binary representations of signal values of +15 to −16 in 5-bit signal data. In the two's complement representation, it is evident that bit values of higher-order bits differ significantly between positive and negative values, with the value zero as a boundary. Therefore, if a signal that frequently changes between positive and negative in the vicinity of the value zero is represented, the bit-wise operation rate will be large. For instance, when a signal value changes from +1 (“00001”) to −1 (“11111”) in the two's complement representation, all four higher-order bits other than the least significant bit (LSB) change. To address this problem, there is a sign magnitude representation, a method for representing digital data having a small bit-wise operation rate in a vicinity of the value zero. In the sign magnitude representation, the most significant bit (MSB) expresses a sign and other bits a magnitude of a value. As an example of the sign magnitude representation, FIG. 19 shows binary representations of signal values of +15 to −16 in 5-bit signal data, corresponding to those in the two's complement representation. In n-bit binary signed magnitude representation, the maximum value that can be expressed is 2\hat{ }(n−1)−1 while the minimum value is −2\hat{ }(n−1)+1, and there are two possible representations for the integer value zero (“00000” and “10000”). Note that, for positive integers, the sign magnitude representation is identical to the two's complement representation. In the sign magnitude representation, with the value zero as a boundary, the difference in bit values between positive and negative values is small. Hence, the bit-wise operation rate is small even when a signal that frequently changes between positive and negative in the vicinity of the value zero is represented. For example, when the signal value changes from +1 (“00001”) to −1 (“10001”), only one bit, the most significant bit, changes.

The sign magnitude representation, however, cannot represent a subtraction processing with an addition processing. Therefore, an addition processing circuit and a subtraction processing circuit must be separately provided, which results in an increase of the scale of a circuit that implements the addition/subtraction processing. Since the circuit scale determines a load capacity C in the dynamic power consumption P shown in Equation (1), an increase in the circuit scale increases a power consumption.

That is, compared with the two's complement representation, the sign magnitude representation can reduce the percentage-activity a, but increases the load capacity C of an addition/subtraction circuit. This causes a problem that a power consumption becomes large for a signal processing including a significant amount of addition/subtraction processing, in particular.

It is conceivable to use the two's complement representation which enables efficient circuit implementation for addition/subtraction processing and use the sign magnitude representation which enables reduction of an operation rate for processing other than addition/subtraction. However, conversion between the two's complement representation and the sign magnitude representation requires bit inversion and add-1 processing (increment processing). This results in a problem that in a case of a circuit requiring a lot of conversion processing, a power consumption increases by that of the conversion circuit.

FIG. 20 illustrates a configuration example of a conversion circuit 600 that performs conversion between the two's complement representation and the sign magnitude representation. The conversion circuit 600 is configured by connecting a bit inversion circuit 601 and an add-one circuit 602. The bit inversion circuit 601 supplies a sign bit IN [N−1], the MSB (Most Significant Bit), as is to an N−1 bit of the add-one circuit 602 and supplies outputs of XOR circuits 607₁ to 607_{N-1}, which receive the sign bit IN [N−1] and each bit IN [i] (i=0, . . . N−2) as inputs, to i bits (i=0, . . . , N−2) of the add-one circuit 602. The add-one circuit 602 adds one to the output of the XOR circuit 607₁ and outputs the addition result as an output bit OUT [i] (i=0, . . . , N−2). In the conversion circuit 600, the add-one circuit 602 in particular has a non-negligible circuit scale, compared with other logic processing circuits and operation processing circuits. Therefore, there is a problem that in a case where a lot of the conversion processing is required, the scale of the entire circuit and power consumption increase by those of the conversion circuits.

It is an object of the present disclosure to provide a signal processing apparatus and method, each enabling suppression or reduction of an increase in scale and power consumption of an entire circuit.

A signal processing apparatus according to an aspect of the present disclosure includes an operation processing part configured to perform operation processing on D-bits data (where D is a positive integer greater than or equal to three) represented in a two's complement representation as a data representation format and a storage processing part configured to perform storage processing on D-bits data represented in a second representation format as a data representation format, wherein the second representation format for a non-negative value of the D-bits data is identical to the two's complement representation therefor, and the second representation format for a negative value of the D-bits data has a representation format in which (D−N−1) bits of the D-bits data represented in the two's complement representation are bit-wise inverted (where N is a positive integer such that N≤D−2), wherein the (D−N−1) bits are remaining bits in the D-bits data obtained by excluding a most significant bit indicating a sign and N consecutive lower bits including a least significant bit therefrom.

A signal processing method according to an aspect of the present disclosure includes performing operation processing on D-bits (D is a positive integer greater than or equal to three) data represented in a two's complement representation as a data representation format and performing storage processing on D-bits data represented in a second representation format as a data representation format, wherein the second representation format for a non-negative value of the D-bits data is identical to the two's complement representation therefor, and the second representation format for a negative value of the D-bits data has a representation format in which (D−N−1) bits of the D-bits data represented in the two's complement representation are bit-wise inverted (where N is a positive integer such that N≤D−2), wherein the (D−N−1) bits are remaining bits in the D-bits data obtained by excluding a most significant bit indicating a sign and N consecutive lower bits including a least significant bit therefrom.

According to the present disclosure, it is possible to realize a signal processing apparatus enabling suppression or reduction of an increase in scale and power consumption of an entire circuit.

### BRIEF DESCRIPTION OF DRAWINGS

FIG. 1 is a diagram schematically illustrating a configuration example of a signal processing apparatus relating to at least one of several example embodiments of the present disclosure.

FIG. 2 is a diagram schematically illustrating a configuration example of a storage processing part relating to at least one of several example embodiments of the present disclosure.

FIG. 3 is a diagram illustrating an example of a data representation format relating to at least one of several example embodiments of the present disclosure in a table format.

FIG. 4 is a diagram schematically illustrating a configuration example of a conversion circuit relating to at least one of several example embodiments of the present disclosure.

FIG. 5 is a graph diagram illustrating an effect relating to at least one of several example embodiments of the present disclosure.

FIG. 6 is a diagram schematically illustrating a configuration example of a signal processing apparatus relating to at least one of several example embodiments of the present disclosure.

FIG. 7 is a diagram schematically illustrating a configuration example of an operation processing part relating to at least one of several example embodiments of the present disclosure.

FIG. 8 is a diagram schematically illustrating a configuration example of a lower-bit mask circuit relating to at least one of several example embodiments of the present disclosure.

FIG. 9 is a diagram schematically illustrating a configuration example of an FFT apparatus relating to at least one of several example embodiments of the present disclosure.

FIG. 10 is a diagram schematically illustrating data sets according to a sequential order in FFT processing relating to at least one of several example embodiments of the present disclosure.

FIG. 11 is a diagram schematically illustrating data sets according to a bit-reversed order in FFT processing relating to at least one of several example embodiments of the present disclosure.

FIG. 12 is a diagram schematically illustrating a configuration example of a butterfly operation processing part relating to at least one of several example embodiments of the present disclosure.

FIG. 13 is a diagram schematically illustrating a configuration example of a twiddle factor multiplication processing part relating to at least one of several example embodiments of the present disclosure.

FIG. 14 is a diagram schematically illustrating a configuration example of a data reordering processing part relating to at least one of several example embodiments of the present disclosure.

FIG. 15 is a time chart describing an operation of the data reordering processing part relating to at least one of several example embodiments of the present disclosure.

FIG. 16 is a diagram illustrating a state of RAM circuits 210a to 210h relating to at least one of several example embodiments of the present disclosure.

FIG. 17 is a diagram illustrating a state of the RAM circuits 210a to 210h relating to at least one of several example embodiments of the present disclosure.

FIG. 18 is a diagram illustrating an example of a 64-point FFT data flow.

FIG. 19 is a diagram illustrating an example of data representation formats in a table format.

FIG. 20 is a block diagram illustrating a configuration example of a conversion circuit.

FIG. 21 is a block diagram illustrating a configuration example of a conversion circuit.

### EXAMPLE EMBODIMENTS

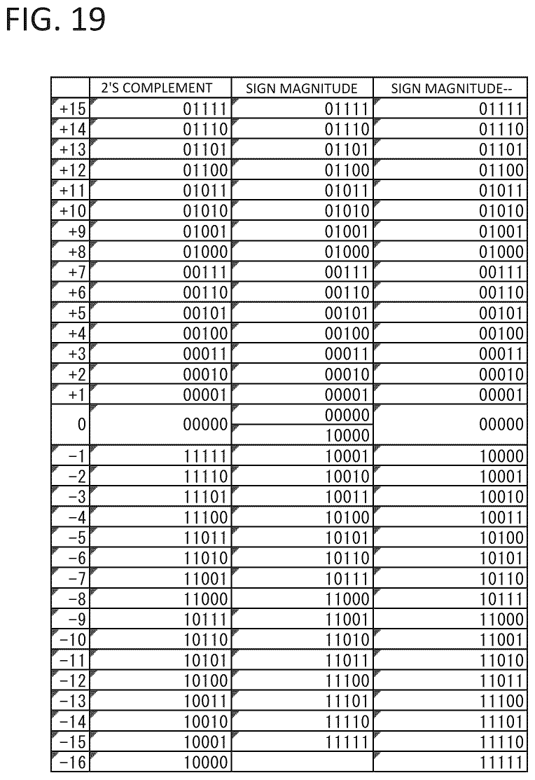

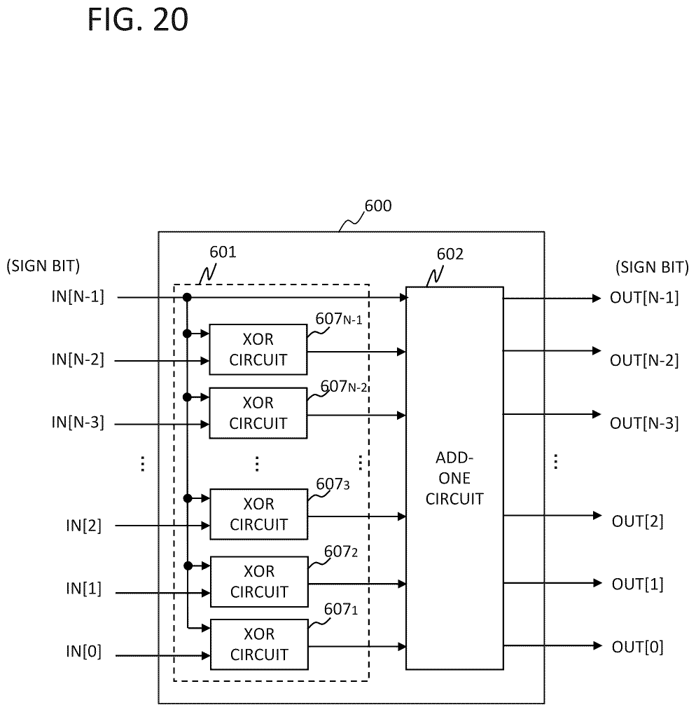

The following describes several example embodiments of the present disclosure. First, as a premise of the present disclosure, the following describes the “sign magnitude-representation” proposed in Patent Literature 1 as a data representation format that reduces a circuit scale and power consumption of the conversion circuit of FIG. 20. As an example of the “sign magnitude-representation,” FIG. 19 shows binary representations of signal values of +15 to −16 in 5-bit signal data, in addition to those in the two's complement representation and the sign magnitude representation. The “sign magnitude-representation” is identical to the two's complement representation when a data value is positive or zero, but all bits lower than the most significant bit indicating a sign in the two's complement representation are bit-wise inverted when the data value is negative. Since the “sign magnitude-representation”is a term used in Patent Literature 1 and not necessarily a commonly used technical term, it was written in quotation marks in the above. Hereinafter, however, it will be written without quotation marks.

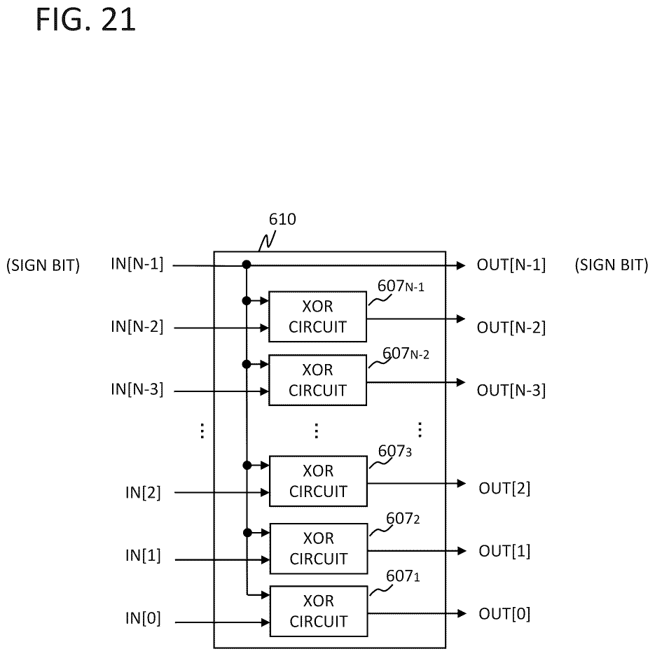

FIG. 21 illustrates a configuration example of a conversion circuit 610 that performs conversion between the two's complement representation and the sign magnitude-representation. A sign bit IN [N−1], the MSB (Most Significant Bit), is outputted as an output bit OUT[N−1], and outputs of XOR circuits 607₁ to 607_{N-1}, which receive the sign bit IN [N−1] and each bit IN [i] (i=0, . . . , N−2) as inputs, are output bits OUT [i] (i=0, . . . , N−2). Conversion between the two's complement representation and the sign magnitude-representation can be achieved only with bit inversion processing performed by the bit inversion circuit 601. Since this does not require add-one processing performed by the add-one circuit 602 (FIG. 20), which is required to perform conversion between the two's complement representation and the sign magnitude representation, a circuit scale and a power consumption of the conversion circuit can be reduced.

However, even in a case where the sign magnitude-representation is used, if the number of conversion circuits is large, there is still a problem that the overall circuit scale and power consumption increase.

The sign magnitude-representation has a problem that it is difficult to use in conjunction with a lower-bit masking technique, which is one of the technologies for reducing power consumption.

The lower-bit masking technique suppresses bit transitions by fixing values of some lower bits of signal data. Although computational accuracy decreases, lower power consumption can be expected due to reduction in bit transitions.

However, if the conversion circuit 610 in FIG. 21 performs conversion processing relating to the sign magnitude-representation after the lower-bit masking processing, the values of the fixed lower bits will change again. For instance, when the values of lower m bits IN[0] to IN [m−1] (m<N−2) are fixed to zero and a sign bit IN [N−1] is one, outputs of m XOR circuits 607₁ to 607ₘ are one. Therefore, there is a problem that the suppression of bit transitions achieved by the lower-bit masking processing is nullified, leading to an increase in power consumption.

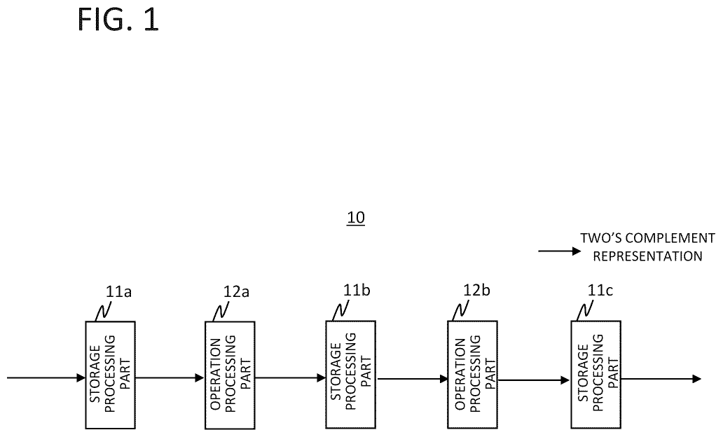

FIG. 1 is a diagram illustrating a configuration example of a signal processing apparatus 10 relating to at least one of several example embodiments of the present disclosure. The signal processing apparatus 10 includes storage processing parts 11a, 11b, and 11c that may perform storage processing such as buffering signal data, re-timing and reordering processing, and operation (arithmetic operation) processing parts 12a and 12b that may perform operation (arithmetic operation) processing such as addition/subtraction and multiplication/division. FIG. 1 illustrates a flow of data in processing (it is noted that signals between the parts are not always unidirectional). The storage processing parts 11a, 11b, and 11c may be referred to as the storage processing parts 11 with the signs a, b, and c omitted except when each part is specified in the description. The same applies to other elements.

The storage processing part 11a is configured to receive signal data represented in the two's complement representation from outside (not shown in the drawing) of the signal processing apparatus 10, perform storage processing, and output the result to the operation processing part 12a.

The operation processing part 12a is configured to receive the signal data represented in the two's complement representation from the storage processing part 11a, perform operation processing, and output a result to the storage processing part 11b.

The storage processing part 11b is configured to receive the signal data represented in the two's complement representation from the operation processing part 12a, perform storage processing, and output the result to the operation processing part 12b.

The operation processing part 12b is configured to receive the signal data represented in the two's complement representation from the storage processing part 11b, perform operation processing, and output a processing result to the storage processing part 11c.

The storage processing part 11c is configured to receive the signal data represented in the two's complement representation from the operation processing part 12b, perform storage processing, and output the result to the outside of the signal processing apparatus 10.

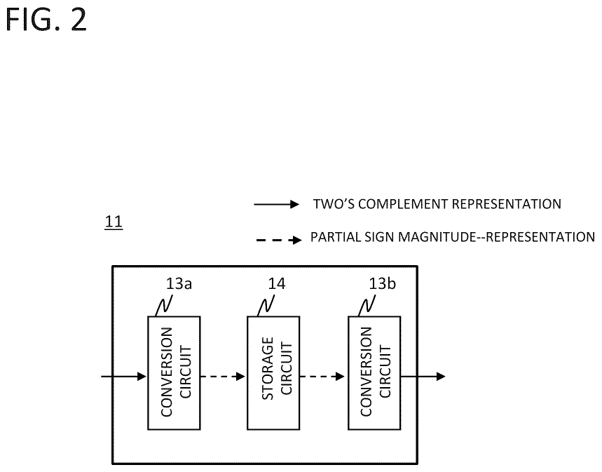

For example, the storage processing parts 11a, 11b, and 11c can be realized by a storage processing part 11 illustrated in FIG. 2.

With reference to FIG. 2, the storage processing part 11 includes a first conversion circuit 13a, a storage circuit 14, and a second conversion circuit 13b.

The first conversion circuit 13a is configured to converts supplied signal data represented in the two's complement representation to signal data represented in “partial sign magnitude-representation” and output the result. It is noted that the “partial sign magnitude-representation” is a term that is used solely herein and is not a common technical term. A “partial sign magnitude-representation” corresponds to a “second representation format” in the Claims. The “partial sign magnitude-representation” is identical to the two's complement representation when a data value of D bits (D is a positive integer greater than or equal to three) is positive or zero, all bits in the two's complement representation are bit-wise inverted except for the most significant bit indicating a sign and the consecutive lower N bits including the least a data value is negative. Hereinafter, the “partial sign magnitude-representation” will be written without quotation marks.

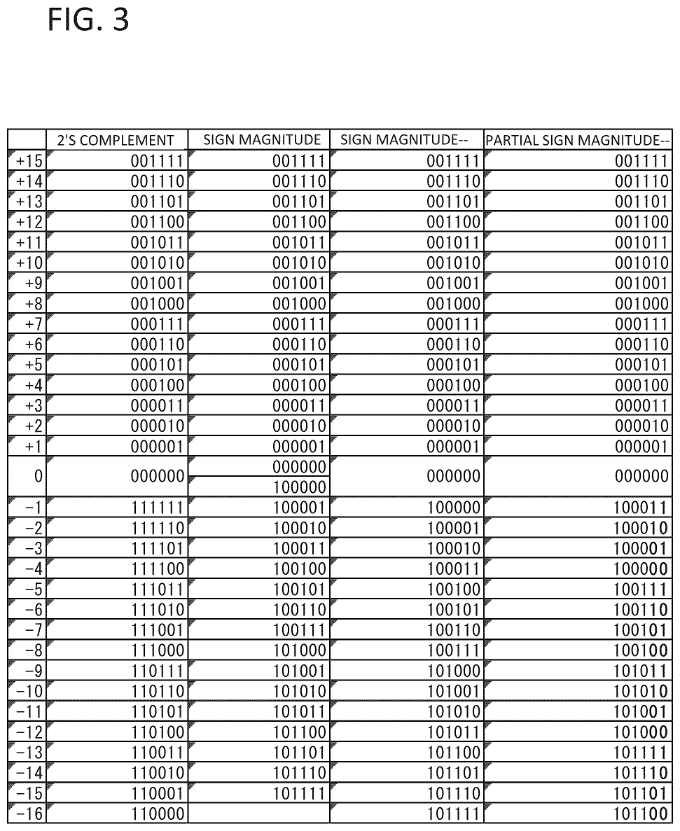

FIG. 3 shows the binary representations of +15 to −16 signal values in 6-bits signal data (D=6; N=2) in the partial sign magnitude-representation and those in the two's complement representation, the sign magnitude representation, and the sign magnitude-representation as a comparison. In FIG. 3, positive data values are represented by the same binary representations (bit values) in the partial sign magnitude-representation, the two's complement representation, the sign magnitude representation, and the sign magnitude-representation.

The data value zero is represented by the same bit value in the partial sign magnitude-representation and the two's complement representation.

When a data value is negative, the partial sign magnitude-representation is obtained by inverting remaining three bits in the two's complement representation, after excluding the most significant bit indicating a sign and two lower bits including the least significant bit. Similarly, when a data value is negative, the two's complement representation is obtained by inverting the remaining three bits in the partial sign magnitude-representation, after excluding the most significant bit indicating a sign and the two lower bits including the least significant bit. Therefore, when a data value is negative, the difference between the partial sign magnitude-representation and the sign magnitude-representation is the two lower bits including the least significant bit.

As illustrated in FIG. 3, with the value zero as a boundary, the difference in bit values between positive and negative values is small in the partial sign magnitude-representation, as in the sign magnitude representation and the sign magnitude-representation. Therefore, when a signal whose value frequently changes between positive and negative in the vicinity of zero is represented, the bit-wise operation rate is small.

For instance, when a signal value changes from +1 to −1, since it changes from +1 (“000001”) to −1 (“100011”) in the partial sign magnitude-representation, a total of two bits changes: the most significant bit and the bit second to the least significant bit.

Meanwhile, since the signal value changes from +1 (“000001”) to −1 (“111111”) in the two's complement representation, a total of five bits other than the least significant bit changes. In the sign magnitude-representation, a change from +1 (“000001”) to −1 (“100000”) entails two changed bits in total: the most significant bit and the least significant bit.

With reference to FIG. 2 again, the storage circuit 14 is a circuit configured to receive signal data represented in the partial sign magnitude-representation outputted by the first conversion circuit 13a, perform storage processing while staying in the partial sign magnitude-representation, and output the result to the second conversion circuit 13b in the partial sign magnitude-representation.

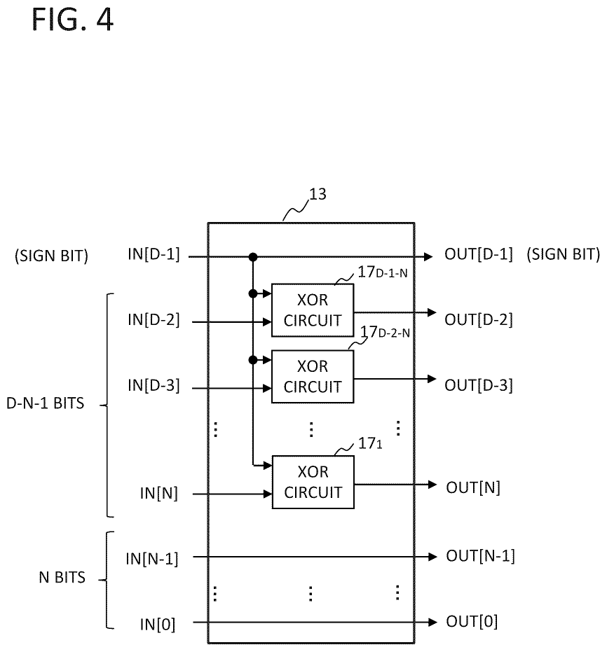

The second conversion circuit 13b is a circuit configured to convert the signal data represented in the partial sign magnitude-representation and outputted by the storage circuit 14 to signal data represented in the two's complement representation and output the result. The first and the second conversion circuits 13a and 13b are configured identically and can be realized by a conversion circuit 13 illustrated in FIG. 4 for example.

With reference to FIG. 4, the conversion circuit 13 is a circuit configured to receive in parallel D-bits (D is a positive integer greater than or equal to three) signal data (IN[0] to IN[D−1]) in the two's complement representation, convert the two's complement representation to the partial sign magnitude-representation, and output the resultant D-bits data (OUT[0] to OUT[D−1]) in parallel. The conversion circuit 13 is further configured to receive in parallel D-bit signal data (IN[0] to IN[D−1]) in the partial sign magnitude-representation, convert the partial sign magnitude-representation to the two's complement representation, and output the resultant D-bits data (OUT[0] to OUT[D−1]) in parallel.

The conversion circuit 13 is configured to receive the most significant bit indicating a sign and output as it is to OUT[D−1] as a sign bit.

The conversion circuit 13 is configured to output consecutive lower N bits including the least significant bit received in parallel from the inputs IN[0] to IN [N−1], as they are, to the outputs OUT[0] to OUT[N−1] in parallel.

The conversion circuit 13 is configured to supply (D−N−1) bits received in parallel from the inputs IN[N] to IN[D−2] to XOR (Exclusive OR) circuits 17₁ to 17_{D-1-N}, respectively, and output in parallel results of XORs between the most significant bit indicating the sign received from the input IN[D−1] and respective ones of the (D−N−1) bits supplied to the XOR (Exclusive OR) circuits 17₁ to 17_{D-1-N} to the outputs OUT [N] to OUT[D−2], respectively.

When an input data value is positive or zero, the value of the most significant bit indicating a sign received from the input IN[D−1] is zero, and the data values supplied to the inputs IN[0] to IN[D−2] are outputted as they are to the outputs OUT[0] to OUT[D−2], respectively.

Conversely, when an input data value is negative, the value of the most significant bit received from the input IN[D−1] and indicating the sign is one, and the data values supplied to the inputs IN[0] to IN [N−1] are outputted as they are to the outputs OUT[0] to OUT[N−1], respectively. Results of XORs between respective data values supplied to the inputs IN[N] to IN[D−2] and the most significant bit having a value of one, i.e., values obtained by inverting respective inputs IN[N] to IN[D−2], are outputted to the outputs OUT [N] to OUT[D−2], respectively.

In the processing described above, the conversion circuit 13 is configured to convert the two's complement representation to the partial sign magnitude-representation and convert the partial sign magnitude-representation to the two's complement representation.

As described above, the conversion circuit 13 achieves conversion between the two's complement representation and the partial sign magnitude-representation only with bit inversion processing and does not require add-one processing, which is required for conversion between the two's complement representation and the sign magnitude representation. Since bit inversion can be implemented with exclusive OR operation (XOR circuit), this can be realized with an overwhelmingly small circuit scale, as compared with other logic processing circuits and operation processing circuits. Further, as compared with the conversion circuit (610 in FIG. 21) configured to perform conversion between the two's complement representation and the sign magnitude-representation, the number of required XOR circuits may be reduced to reduce a scale of the conversion circuit 13.

As described above, in the storage processing parts 11a, 11b, and 11c, the signal processing apparatus 10 is configured to convert data represented in the two's complement representation to data in the partial sign magnitude-representation, perform storage processing thereon, and then convert the data back to the two's complement representation. As illustrated in FIG. 3, with a value zero as a boundary, the difference in bit values between positive and negative values is small in the partial sign magnitude-representation, as in the sign magnitude representation. Hence, when a signal with a value that frequently changes between positive and negative in the vicinity of zero is represented in the partial sign magnitude-representation, the bit-wise operation rate is small. As a result, the percentage-activity of the storage processing parts 11a, 11b, and 11c can be reduced, compared with a case where the processing takes place without converting the two's complement representation.

The conversion circuit 13 is configured to perform conversion between the two's complement representation and the partial sign magnitude-representation only with bit inversion processing and does not require add-one processing (increment processing), which is required when using the sign magnitude representation. Bit inversion can be achieved only with an XOR circuit. Therefore, this can be implemented with an overwhelmingly small circuit scale, as compared with other logic processing circuits and operation processing circuits. As compared with conversion between the two's complement representation and the sign magnitude-representation, the number of required XOR circuits is smaller, and the scale of the conversion circuit 13 can be reduced accordingly.

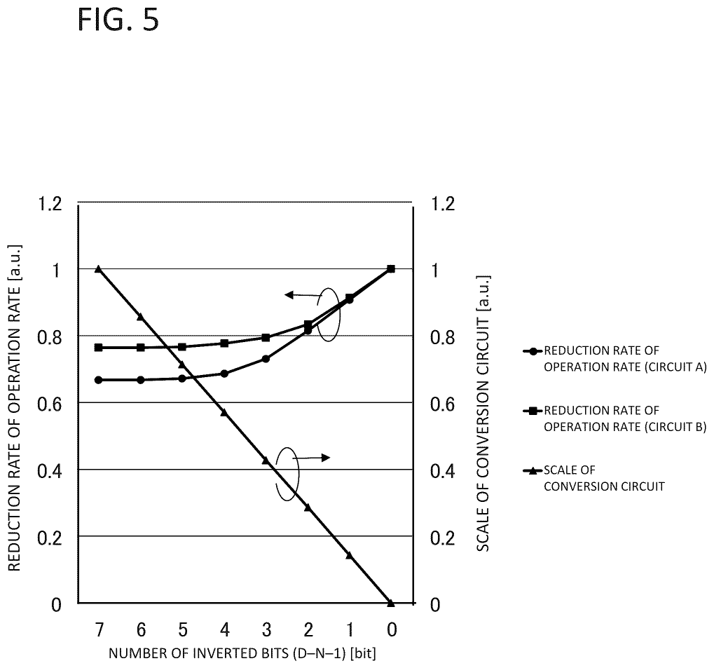

FIG. 5 is a graph showing an effect(s) of the partial sign magnitude-representation applied to two example circuits, circuit A and circuit B, with respect to a storage processing part in an FFT processing circuit, in which the bit width of signal data is eight bits (D=8). In FIG. 5, the number of inverted bits (D−N−1) on the horizontal axis is the number of bits (D−N−1 in FIG. 3) inverted in conversion between the two's complement representation and the partial sign magnitude-representation.

When the number of inverted bits (D−N−1) is zero (N=D−1), there is no inverted bit, and this is the same as the two's complement representation.

When the number of inverted bits (D−N−1) is seven (=D−1), N=0. Since all the bits except for the sign bit are bit-wise inverted, this is the same as the sign magnitude-representation.

A case where the number of inverted bits (D−N−1 in FIG. 3) is one to six corresponds to the partial sign magnitude-representation.

In FIG. 5, the left vertical axis is a reduction rate of the bit-wise operation rate which indicates a relative value based on the operation rate in two's complement representation. The right vertical axis is a scale of the conversion circuit which indicates a relative value based on the scale of the conversion circuit in the sign magnitude-representation.

With reference to FIG. 5, for instance, in a case where the number of inverted bits is four, the bit-wise operation rates of the circuits A and B in the partial sign magnitude-representation are reduced to 20 to 30 percent of those in a case where the two's complement representation is used. This is the same reduction rate as when the sign magnitude-representation is used. Meanwhile, the circuit scale is reduced to 40 percent of a case where the sign magnitude-representation is used. That is, according to the present example embodiment, with a conversion circuit smaller than that in the sign magnitude-representation, the bit-wise operation rate can be reduced to the same extent as the sign magnitude-representation.

Therefore, in the present example embodiment, even when processing a signal with a value which frequently changes between positive and negative in the vicinity of zero, it is possible to keep the percentage-activity in the storage processing parts 11a, 11b, and 11c to a minimum. As a result, the power consumption in the storage processing parts 11a, 11b, and 11c can be reduced.

In the present example embodiment, the operation processing parts 12a and 12b perform operation processing in the two's complement representation. Therefore, the percentage-activity related to operation processing is not reduced. The conversion between the data representation formats, however, does not increase the circuit scale unlike in the case where the sign magnitude representation is applied. Therefore, according to the example embodiment, the power consumption of the entire signal processing apparatus can be reduced by a reduction amount of power consumption in the storage processing parts 11a, 11b, and 11c.

In the present example embodiment, although the storage processing parts 11a, 11b, and 11c perform storage processing on data such as buffering, re-timing, and rearranging signal data in the partial sign magnitude-representation and the operation processing parts 12a and 12b perform operation processing such as addition/subtraction and multiplication/division of data in the two's complement representation, the storage processing parts 11a, 11b, and 11c may perform operation processing such as addition/subtraction and multiplication/division of data based on the partial sign magnitude-representation if a desired result can be obtained from the processing on data in the partial sign magnitude-representation, in addition to the storage processing.

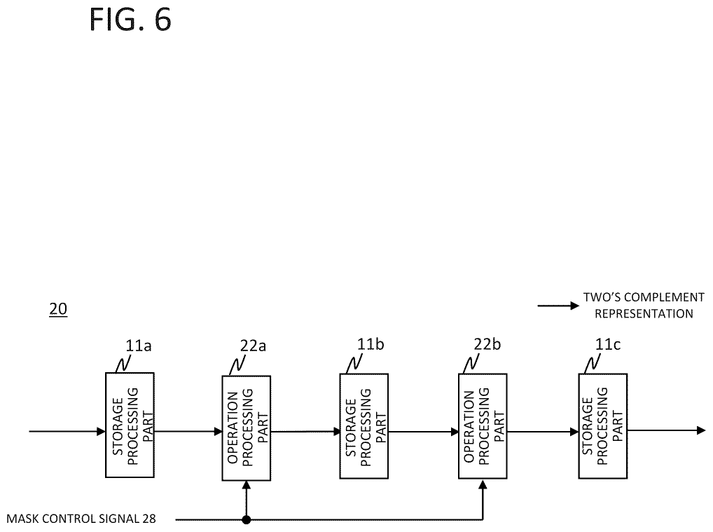

The following describes another example of several example embodiments of the present disclosure. FIG. 6 is a diagram illustrating a configuration example of a signal processing apparatus 20 relating to at least one of several example embodiments of the present disclosure. The signal processing apparatus 20 in this example includes storage processing parts 11a, 11b, and 11c that perform storage processing such as buffering signal data and re-timing and reordering processing, and operation processing parts 22a and 22b that perform operation processing such as addition/subtraction and multiplication/division. The storage processing parts 11a, 11b, and 11c are configured identically to the storage processing parts in the signal processing apparatus 10 relating to the example embodiment described above and given the same reference signs. The operation processing parts 22a and 22b receive a mask control signal 28, which is a control signal supplied from a higher-level control circuit (not shown in the drawing) such as a CPU (Central Processing Unit) (also not shown in the drawing).

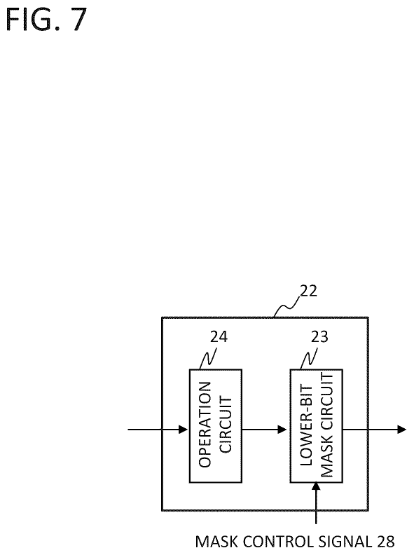

With reference to FIG. 7, an operation processing part 22 that constitutes the operation processing parts 22a and 22b includes an operation circuit 24 and a lower-bit mask circuit 23. The operation circuit 24 is an arithmetic operation circuit such as an addition circuit, a subtraction circuit, a multiplication circuit, and a division circuit. The lower-bit mask circuit 23 fixes values of some lower bits of signal data outputted by the operation circuit 24. By fixing the values of some lower bits, bit-wise operation is suppressed with an aim to reduce power consumption. While fixing the values of some lower bits in data reduces computational accuracy, it also decreases the bit-wise operation rate. Therefore, a corresponding reduction in power consumption can be expected.

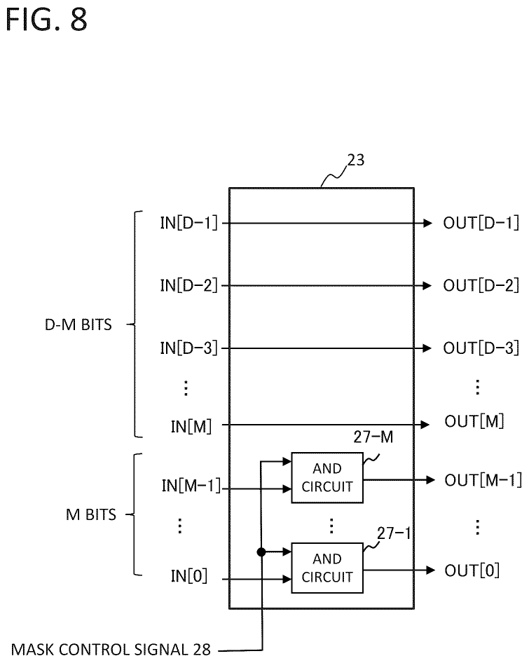

For instance, the lower-bit mask circuit 23 can be realized with a configuration shown in FIG. 8. With reference to FIG. 8, the lower-bit mask circuit 23 receives in parallel D-bits (D is a positive integer greater than or equal to three) signal data (IN[0] to IN[D−1]) in the two's complement representation, fixes values of M lower bit or bits including a least significant bit (M is a positive integer greater than or equal to one) to zero according to a value of the supplied mask control signal 28, and outputs the resultant D-bits data (OUT[0] to OUT[D−1]) in parallel.

More specifically, D−M bits (M is a positive integer greater than or equal to one) received from the inputs IN[M] to IN[D−1] are outputted as they are to the outputs OUT[M] to OUT[D−1], respectively. The M lower bit or bits including a least significant bit received from the inputs IN[0] to IN[M−1] are ANDed with the supplied mask control signal 28 by AND circuits 27-1 to 27-M, respectively, and then outputted to the outputs OUT[0] to OUT[M−1], respectively. In other words, if the value of the mask control signal 28 is one, the signal data supplied to the inputs IN[0] to IN[M−1] are outputted as they are to the outputs OUT[0] to OUT[M−1].

Meanwhile, if the value of the mask control signal 28 is zero, regardless of the values of the signal data supplied to the inputs IN[0] to IN[M−1], zero is outputted to the outputs OUT[0] to OUT[M−1]. Therefore, although fixing the values of M bits at the outputs OUT [0] to OUT[M−1] to zero decreases computational accuracy, power consumption is expected to be reduced by the amount of bit transitions eliminated. In other words, depending on whether the value of the mask control signal 28 is one or zero, it is possible to control whether to prioritize computational accuracy or low power consumption.

In FIG. 6, the storage processing parts 11a, 11b, and 11c are configured identically to the storage processing part 11 shown in FIG. 2. A conversion circuit 13 that constitutes the storage processing part 11 is configured as illustrated in FIG. 4; however, there is a restriction on the range of the N least significant bits that are not inverted. More specifically, M and N are set so that N is always greater than or equal to M with respect to the M lower bit or bits including a least significant bit whose values are fixed in the lower-bit mask circuit 23 and the N least significant bits that are not inverted in the conversion circuit 13. More specifically, M and N are set so that the following is satisfied for D-bits data. 1≤M≤N≤D−2. In other words, the M lower bit or bits including a least significant bit whose values are fixed to zero in the lower-bit mask circuit 23 are not inverted in the conversion circuit 13. As a result, the values of the M lower bit or bits including a least significant bit remain fixed at zero even when the partial sign magnitude-representation is used. Therefore, the reduction effect of the percentage-activity is not nullified by the lower-bit mask circuit 23.

As in the signal processing apparatus 10 described above, with the partial sign magnitude-representation, it is also possible to reduce the percentage-activity in the storage processing parts 11a, 11b, and 11c in the signal processing apparatus 20 of the present example embodiment, when processing a signal with a value which frequently changes between positive and negative in the vicinity of zero, which leads to reduction of power consumption in the storage processing parts 11a, 11b, and 11c.

In the present example embodiment, the bit-wise operation rate is suppressed by having the lower-bit mask circuit 23 fix values of lower bits in the operation processing part 12. Moreover, unlike in the sign magnitude-representation, the bits whose values are fixed are not inverted and remain fixed in the partial sign magnitude-representation in the present example embodiment. Therefore, it is possible to take advantage of both a power-saving effect of the lower-bit masking processing and a power-saving effect of the partial sign magnitude-representation.

As a further example of several example embodiments of the present disclosure, the following describes an example in which the present disclosure is applied to an FFT apparatus. The FFT apparatus includes a butterfly operation processing part configured to perform butterfly operation processing, a twiddle factor multiplication processing part configured to perform twiddle factor multiplication, and a data reordering processing part configured to rearrange an order of a plurality of pieces of data. The butterfly operation processing part and the twiddle factor multiplication processing part is configured to process D-bits data (D is a positive integer greater than or equal to three) represented in the two's complement representation, and the data reordering processing part is configured to perform storage processing on D-bits data represented in the partial sign magnitude-representation.

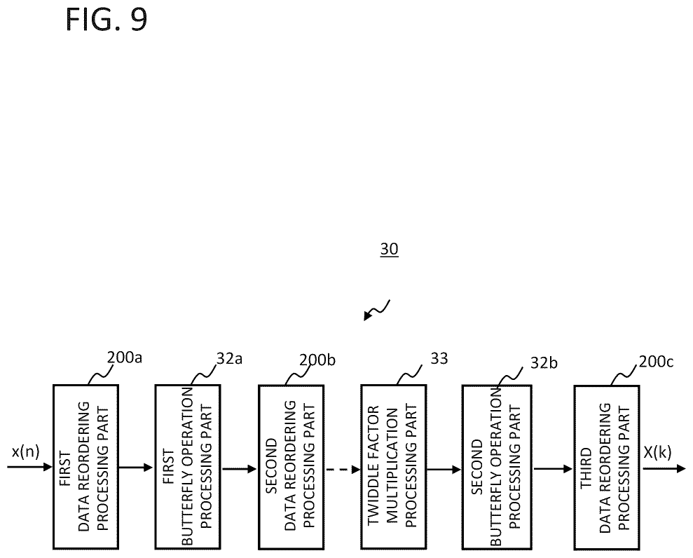

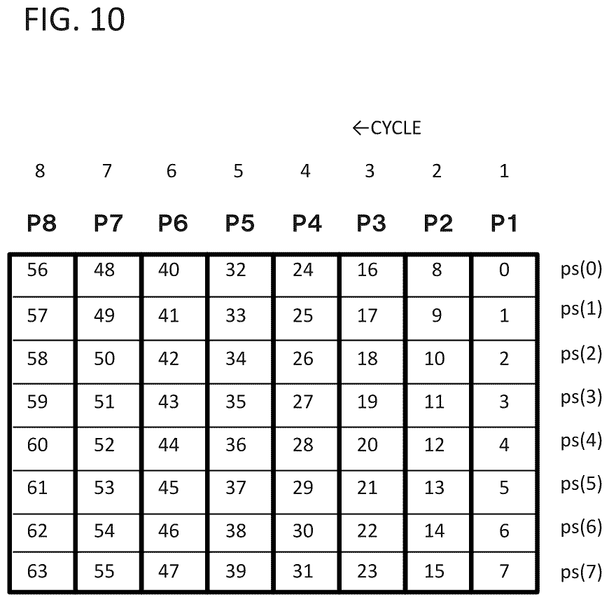

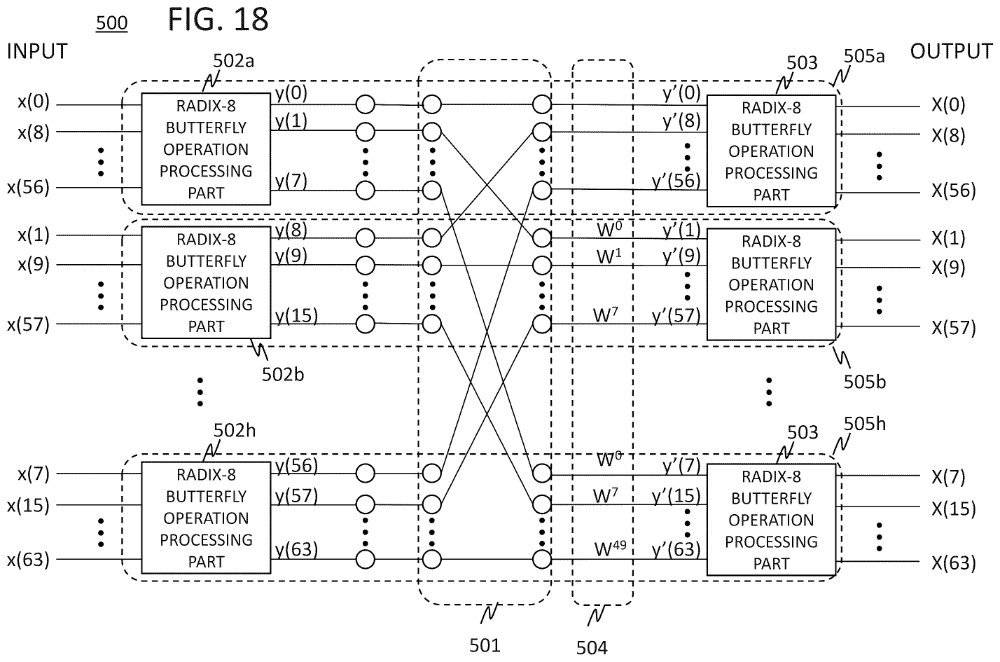

FIG. 9 is a diagram schematically illustrating an example of an FFT apparatus 30 relating to an example embodiment of the present disclosure. The FFT apparatus 30 is configured to process 64-point FFT decomposed into two-stages of radix-8 butterfly processing, using a pipeline circuit scheme, according to the data flow 500 illustrated in FIG. 18. The FFT apparatus 30 is configured to receive time-domain data x(n) (n=0, 1, . . . , N−1), perform Fourier-transformation on x(n) using FFT processing, and generate and output frequency-domain signals X(k) (k=0, 1, . . . , N−1). Here, N is a positive integer representing a FFT block size. It is assumed that the FFT apparatus 30 performs a 64-point FFT process in 8-data parallel (N=64), as a non-limiting example. In this case, the FFT apparatus 30 receives the time-domain data x(n) and generates and outputs the frequency-domain signals X(k), which have been Fourier-transformed using FFT processing. 64 pieces of data in total, eight pieces at a time in eight cycles, are inputted as the input data x(n) in the order as illustrated in FIG. 10. The numbers from 0 to 63 (eight rows×eight columns of elements) shown in a table in FIG. 10 represent an index n of x(n).

More specifically, in the first cycle, eight pieces of data x(0), x(1), . . . and x(7) constituting a data set P1 are inputted.

Then, eight pieces of data x(8), x(9), . . . , and x(15) constituting a data set P2 are inputted in the second cycle. Similarly, in each cycle from the third to the eighth, data constituting data sets P3 to P8 are inputted thereafter, respectively.

Likewise, 64 pieces of data, eight pieces of data at a time in eight cycles, are outputted as output data X(k) in the order illustrated in FIG. 10. Note that the numbers from 0 to 63 shown in the table in FIG. 10 represent an index k of X(k).

More specifically, in the first cycle, eight pieces of data x(0), x(1), . . . and x(7) constituting the data set P1 are outputted.

Eight pieces of data x(8), x(9), . . . , and x(15) constituting the data set P2 are outputted in the second cycle. Similarly, in each cycle from the third to the eighth, data constituting the data sets P3 to P8 are outputted thereafter, respectively.

As illustrated in FIG. 9, the FFT apparatus 30 includes a first data reordering processing part 200a, a first butterfly operation processing part 32a, a second data reordering processing part 200b, a twiddle factor multiplication processing part 33, a second butterfly operation processing part 32b, and a third data reordering processing part 200c.

The FFT apparatus 30 is configured to perform first data reordering processing, first butterfly operation processing, second data reordering processing, twiddle factor multiplication processing, second butterfly operation processing, and third data reordering processing, in pipeline processing.

The first data reordering processing part 200a and the second data reordering processing part 200b include buffer circuits to rearrange data. The first data reordering processing part 200a and the second data reordering processing part 200b are configured to rearrange a data sequence before and after the first butterfly operation processing part 32a, respectively, based on data dependency in an FFT processing algorithm.

Likewise, the third data reordering processing part 200c is a buffer circuit to rearrange data. That is, the third data reordering processing part 200c is configured to rearrange a data sequence after the second butterfly operation processing part 32b based on the data dependency in the algorithm of the FFT processing.

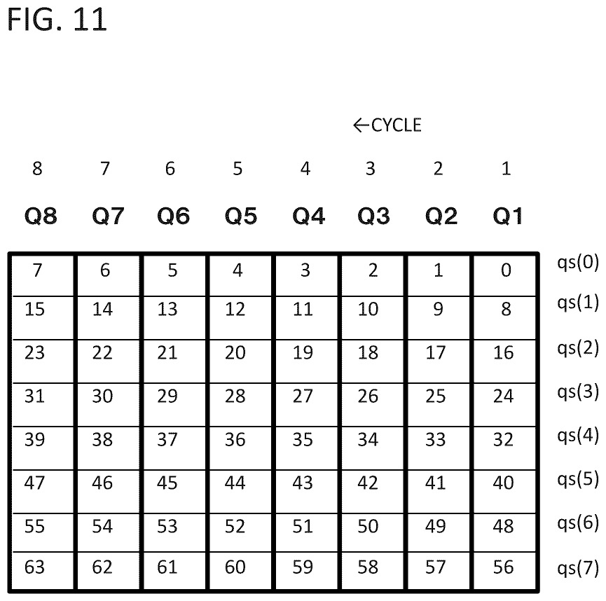

More specifically, the first data reordering processing part 200a is configured to rearrange a “sequential order” as illustrated in FIG. 10, which is an input order of the input data x(n), to a “bit-reversed order” as illustrated in FIG. 11, which corresponds to an order with which data is supplied to the first butterfly operation processing part 32a.

The bit-reversed order illustrated in FIG. 11 corresponds to input data sets supplied to the radix-8 butterfly operation processing part 502 in the first stage in the data flow diagram illustrated in FIG. 18.

More specifically, in a first cycle, eight pieces of data x(0), x(8), and x(56) constituting a data set Q1 are inputted. Then, eight pieces of data x(1), x(9), . . . , and x(57) constituting a data set Q2 are inputted in a second cycle. Similarly, in each cycle from a third to an eighth, data constituting data sets Q3 to Q8 are inputted thereafter, respectively.

A sequential order is an order of eight data sets P1, P2, P3, P4, P5, P6, P7, and P8 as illustrated in FIG. 10. A data set Ps (where s is a value representing an order of a processing cycle; s=1, 2, . . . , 8) is constituted by eight pieces of data sequentially arranged from ps(0) to ps(7).

Assuming that x(0) to x(63), 64 pieces of data in total, every eight pieces in each cycle (total, eight cycles), are inputted in parallel in the order illustrated in FIG. 10, ps(i) (s, i=0, . . . , 7) is given as follows:

$$ps ( i ) = x [ 8 \times ( s - 1 ) + i ]$$

The data sets are arranged in the order of P1, P2, P3, P4, P5, P6, P7, and P8 corresponding to the progress of the processing cycles. In the sequential order, s sets of data, in which i*s pieces of data are arranged from the first data to the last, by every i pieces of data, in the order of data are arranged in the order of cycles.

A bit-reversed order is an order of the eight data sets Q1, Q2, Q3, Q4, Q5, Q6, Q7, and Q8 illustrated in FIG. 11. A data set Qs (where s is a value representing an order of a processing cycle; s=1, 2, . . . , 8) is constituted by eight pieces of data sequentially arranged from qs(0) to qs(7). For 64 pieces of data x(0) to x(63) supplied in the sequential order, qs(i) (s, i=0, . . . , 7) is given as follows:

$$qs ( i ) = x [ ( s - 1 ) + 8 \times i ]$$

The data sets are arranged in the order of Q1, Q2, Q3, Q4, Q5, Q6, Q7, and Q8 corresponding to the progress of the processing cycles. In the bit-reversed order, s pieces out of i*s pieces of data supplied in the sequential order are arranged from the first piece in the order of cycles, and i pieces of data in the same cycle are sequentially arranged as a set.

Each data set in the bit-reversed order is uniquely determined in a case where each data set in the sequential order is configured. The i-th data Qs(i) (i=0, . . . , 7) out of data constituting each data set Qs (s=1, . . . , 8) in the bit-reversed order is the (s−1)-th piece of data Pᵢ₊₁ (s−1) in the (i+1)-th cycle according to the sequential order. That is,

$$Qs ( i ) = {P}_{i + 1} ( s - 1 )$$

Here, if the i-th data in Ps and Qs (s=1, . . . , 8) are represented by Ps(i) and Qs(i) (i=1, . . . , 8), the above equation is expressed as:

Qs(i)=Pi(s)

That is, Qs(i) and Pi(s) have a relationship in which the progress order of cycles is replaced by the order of data positions with respect to pieces of data constituting each data set. Hence, if pieces of data supplied in the bit-reversed order are rearranged according to the bit-reversed order, they will form a sequence in the sequential order.

Each row pₛ(i) in FIG. 10 and eight rows qₛ(i) in FIG. 11 represent the i-th data to be supplied in the subsequent stage. Each of eight numerals included in each data set is an identifier specifying an FFT point and is specifically the index n in x(n).

The sequential order and the bit-reversed order are, as a matter of course, not limited to those illustrated in FIGS. 10 and 11. Each data set in the sequential order can be created by sequentially arranging data according to the number of FFT points, the number of cycles, and the number of data processed in parallel, as described above. Each data set in the bit-reversed order can be created by replacing the order of cycle progression with the order of data position, for data supplied in the sequential order, as described above.

The first butterfly operation processing part 32a is configured to perform the first butterfly operation processing 502 (the first butterfly operation process) of the radix-8 butterfly operation processing performed twice in the data flow 500 illustrated in FIG. 18.

The first butterfly operation processing part 32a is configured to output the results of the butterfly operation in the sequential order as illustrated in FIG. 10 as data y(n) (n=0, 1, . . . , 63).

The second data reordering processing part 200b is configured to rearrange the data y(n) outputted in the sequential order by the first butterfly operation processing part 32a to the bit-reversed order as illustrated in FIG. 11 in order to supply the data to the second butterfly operation processing part 32b.

The twiddle factor multiplication processing part 33 is configured to apply complex rotation on a complex plane of the FFT operation after the first butterfly operation, which corresponds to the twiddle factor multiplication processing part 504 in the data flow 500 illustrated in FIG. 18. Data rearrangement is not performed in the twiddle factor multiplication process.

The second butterfly operation processing part 32b, which corresponds to a butterfly operation processing circuit, is configured to perform the butterfly operation processing by the radix-8 butterfly operation processing part 503 in the data flow diagram illustrated in FIG. 18. The second butterfly operation processing part 32b is configured to perform butterfly operation processing on data y′(n) (n=0, 1, . . . , 63) supplied in the bit-reversed order after the twiddle factor multiplication, and output the results X(k) (k=0, 1, . . . , 63), also in the bit-reversed order.

The third data reordering processing part 200c is configured to rearrange the data X(k) outputted in the bit-reversed order by the second butterfly operation processing part 32b to the sequential order illustrated in FIG. 10.

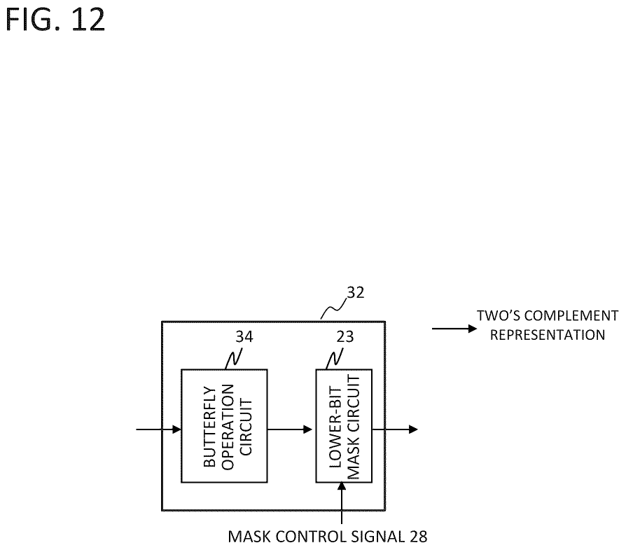

With reference to FIG. 12, a butterfly operation processing part 32 constituting the first butterfly operation processing part 32a and the second butterfly operation processing part 32b includes a butterfly operation circuit 34 and a lower-bit mask circuit 23.

The first butterfly operation processing part 32a is configured to fix values of the M lower bit or bits including a least significant bit (M is a positive integer greater than or equal to one) in output signal data according to control of the mask control signal 28, thereby reducing the bit-wise operation rate of signal data in the second data reordering processing part 200b and the twiddle factor multiplication processing part 33.

Likewise, the second butterfly operation processing part 32b is configured to fix values of the M lower bit or bits including a least significant bit in output signal data according to control of the mask control signal 28, thereby reducing the bit-wise operation rate of signal data in the third data reordering processing part 200c.

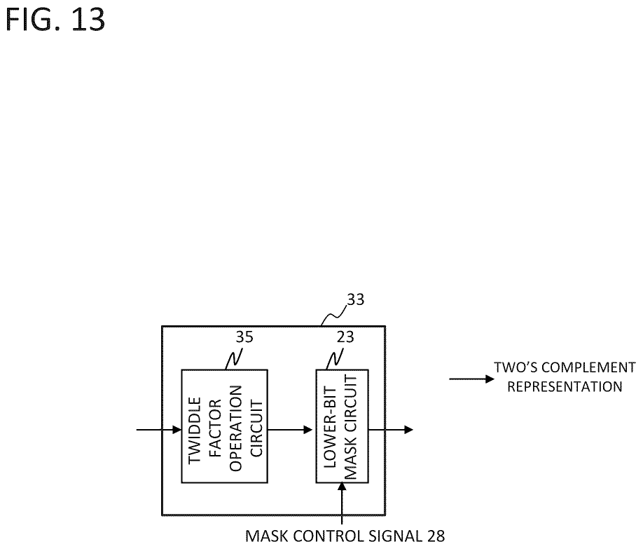

With reference to FIG. 13, the twiddle factor multiplication processing part 33 includes a twiddle factor operation circuit 35 and a lower-bit mask circuit 23. The twiddle factor multiplication processing part 33 is configured to fixe values of the M lower bit or bits including a least significant bit in output signal data according to control of the mask control signal 28, thereby reducing the bit-wise operation rate of signal data in the second data reordering processing part 200b and the twiddle factor multiplication processing part 33.

The data reordering processing part 200 is configured to realize data reordering processing according to the sequential order illustrated in FIG. 10 and the bit-reversed order illustrated in FIG. 11 by temporarily storing received data and controlling selection and output of the stored data. The following describes a concrete example of the data reordering processing part 200.

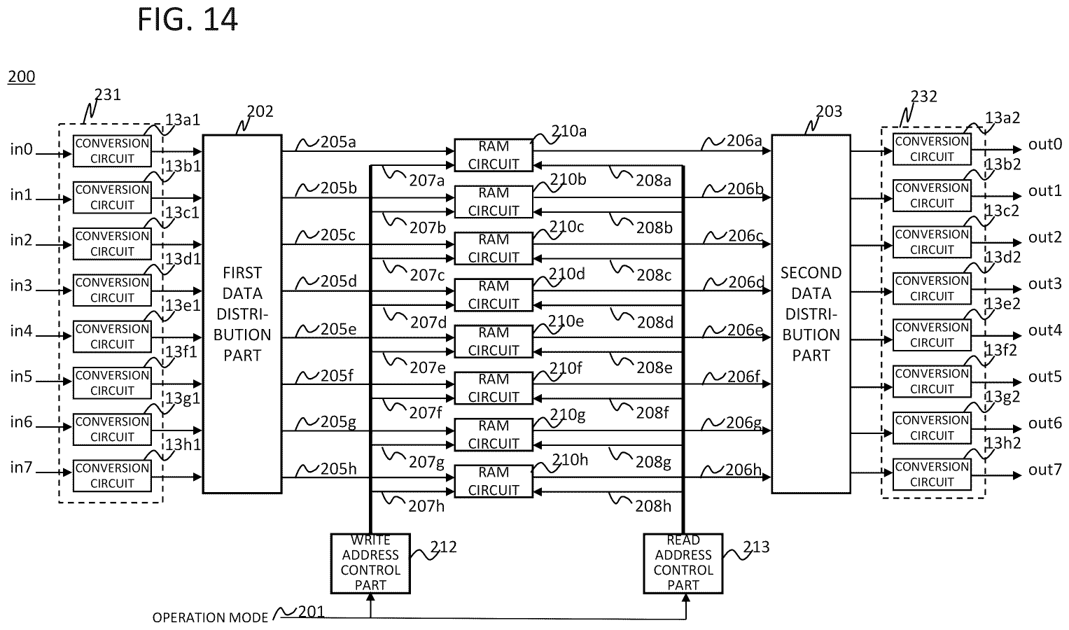

With reference to FIG. 14, the data reordering processing part 200 includes a first conversion circuit 231, a first data distribution part 202, eight RAM (Random Access Memory) circuits 210a, 210b, 210c, 210d, 210e, 210f, 210g, and 210h, a second data distribution part 203, a write address control part 212, a read address control part 213, and a second conversion circuit 232.

The first conversion circuit 231 simultaneously is configured to receive (in parallel) eight pieces of data (D-bits data in the two's complement representation) supplied from eight inputs in0 to in7 in the sequential order illustrated in FIG. 10 and convert the data in two's complement representation to those in the partial sign magnitude-representation.

The first conversion circuit 231 is constituted by eight conversion circuits 13a1 to 13h1 corresponding to the eight inputs in0 to in7. The conversion circuits 13a1 to 13h1 are configured to convert the data in two's complement representation, supplied to each input in parallel, to those in the partial sign magnitude-representation. More specifically, the conversion circuits are configured to convert the data to those in the partial sign magnitude-representation by inverting all bits in the supplied D-bits data except for the most significant bit indicating the sign and the N least significant bits (N is a positive integer such that M N≤D−2). Here, M is the number of lower bits whose values are fixed by the lower-bit mask circuit 23.

The first data distribution part 202 are configured to perform data distribution processing on the eight pieces of data converted to the partial sign magnitude-representation by the first conversion circuit 231 and output the results to eight outputs (data lines) 205a to 205h.

Each of the eight RAM circuits 210a to 210h is a RAM circuit enabled to store eight pieces of data. Therefore, the RAM circuits 210a to 210h are enabled to store a total of 64 pieces of data (8×8: 8 in parallel, depth 8), which is equal to the number of points in a 64-point FFT. Each of the RAM circuits 210a to 210h may be a dual-port RAM circuit that includes independent write and read ports and prioritizes reading when both writing and reading occur at the same address simultaneously. That is, after reading data stored at a target address for writing and reading, the RAM circuit writes data to be written. The RAM circuits 210a to 210h may be constituted by dual-port SRAMs (Static Random Access Memory) and DRAMs (Dynamic Random Access Memory). In the RAM circuits 210a to 210h, control terminals such as chip enable (CE), output enable (OE), and write enable (WE), and control signals supplied to these control terminals are omitted.

The RAM circuit 210a is configured to store the data outputted by the first data distribution part 202 to the data line (D bit) 205a at an address outputted by the write address control part 212 to an address line 207a, read the stored data using an address outputted by the read address control part 213 to an address line 208a, and output the result to a data line 206a.

Likewise, the RAM circuit 210b is configured to store the data outputted by the first data distribution part 202 to the data line 205b at an address outputted by the write address control part 212 to an address line 207b, read the stored data using an address outputted by the read address control part 213 to an address line 208b, and outputs the result to a data line 206b.

The RAM circuit 210c is configured to store the data outputted by the first data distribution part 202 to the data line 205c at an address outputted by the write address control part 212 to an address line 207c, read the stored data using an address outputted by the read address control part 213 to an address line 208c, and output the result to a data line 206c.

The RAM circuit 210d is configured to store the data outputted by the first data distribution part 202 to the data line 205d at an address outputted by the write address control part 212 to an address line 207d, read the stored data using an address outputted by the read address control part 213 to an address line 208d, and output the result to a data line 206d.

The RAM circuit 210e is configured to store the data outputted by the first data distribution part 202 to the data line 205e at an address outputted by the write address control part 212 to an address line 207e, read the stored data using an address outputted by the read address control part 213 to an address line 208e, and output the result to a data line 206e.

The RAM circuit 210f is configured to store the data outputted by the first data distribution part 202 to the data line 205f at an address outputted by the write address control part 212 to an address line 207f, read the stored data using an address outputted by the read address control part 213 to an address line 208f, and output the result to a data line 206f.

The RAM circuit 210g is configured to store the data outputted by the first data distribution part 202 to the data line 205g at an address outputted by the write address control part 212 to an address line 207g, read the stored data using an address outputted by the read address control part 213 to an address line 208g, and output the result to a data line 206g.

The RAM circuit 210h is configured to store the data outputted by the first data distribution part 202 to the data line 205h at an address outputted by the write address control part 212 to an address line 207h, read the stored data using an address outputted by the read address control part 213 to an address line 208h, and output the result to a data line 206h.

The second data distribution part 203 is configured to simultaneously receive eight pieces of data from the eight inputs (data lines) 206a to 206h, perform data distribution processing, and output the results to the second conversion circuit 232.

The second conversion circuit 232 is configured to convert each of the eight pieces of data in the partial sign magnitude-representation to data in the two's complement representation, the eight pieces of data reordered by the second data distribution part 203 to the “bit-reversed order”. The second conversion circuit 232 is constituted by eight conversion circuits 13a2 to 13h2 corresponding to eight inputs. Each of the conversion circuits 13a2 to 13h2 is configured to convert the supplied data in the two's complement representation to data in the partial sign magnitude-representation.

More specifically, the conversion circuits are configured to convert the data to those in the partial sign magnitude-representation by inverting (D−N−1) bits in D-bits data excluding the most significant bit indicating the sign and the N lower bits including the least significant bits (N is a positive integer such that M≤N≤D−2). Here, M is the number of lower bits whose values are fixed by the lower-bit mask circuit 23.

The write address control part 212 is configured to refer to the operation mode 201 and output the addresses with which the RAM circuits 210a to 210h write data to the address lines 207a to 207h, respectively.

The read address control part 213 is configured to refer to the operation mode 201 and output the addresses with which the RAM circuits 210a to 210h read data to the address lines 208a to 208h, respectively.

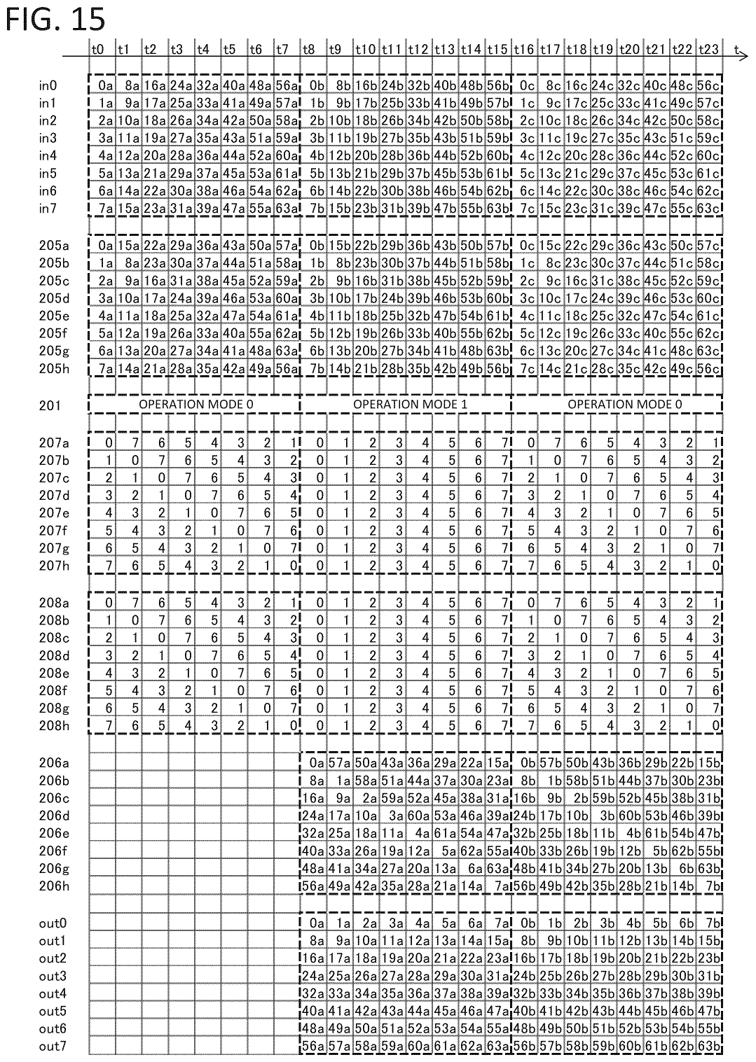

The next describes a specific operation of the data reordering processing part 200d. FIG. 15 is a time chart showing an example of an operation of the data reordering processing part 200.

The data reordering processing part 200
receives 64 pieces of data 0a to 63a in 8-data parallel in the sequential order from the inputs in0 to in7 in eight cycles t0 to t7 and
outputs 64 pieces of data 0a to 63a in 8-data parallel in the bit-reversed order to outputs out0 to out7 in eight cycles t8 to t15.

Likewise, the data reordering processing part 200
receives 64 pieces of data 0b to 63b in 8-data parallel in the sequential order from the inputs in0 to in7 in the eight cycles t8 to t15 and
outputs 64 pieces of data 0b to 63b in 8-data parallel in the bit-reversed order to the outputs out0 to out7 in eight cycles t16 to t23.

The data reordering processing part 200
receives 64 pieces of data 0c to 63c in 8-data parallel in the sequential order from the inputs in0 to in7 in the eight cycles t16 to t23 and
outputs 64 pieces of data 0c to 63c in 8-data parallel in the bit-reversed order to the outputs out0 to out7 in eight cycles t24 to t31 (not shown in the drawing).

First, the following describes in detail how the data reordering processing part 200 receives the data 0a to 63a in the eight cycles t0 to t7.

In the cycle t0,
the first data distribution part 202
outputs to the data line 205a the data 0a received from in0 and converted by the first conversion circuit 231 from the two's complement representation to the partial sign magnitude-representation,
outputs to the data line 205b the data 1a received from in1 and converted by the first conversion circuit 231 from the two's complement representation to the partial sign magnitude-representation,
outputs to the data line 205c the data 2a received from in2 and converted by the first conversion circuit 231 from the two's complement representation to the partial sign magnitude-representation,
outputs to the data line 205d the data 3a received from in3 and converted by the first conversion circuit 231 from the two's complement representation to the partial sign magnitude-representation,
outputs to the data line 205e the data 4a received from in4 and converted by the first conversion circuit 231 from the two's complement representation to the partial sign magnitude-representation,
outputs to the data line 205f the data 5a received from in5 and converted by the first conversion circuit 231 from the two's complement representation to the partial sign magnitude-representation,
outputs to the data line 205g the data 6a received from in6 and converted by the first conversion circuit 231 from the two's complement representation to the partial sign magnitude-representation, and
outputs to the data line 205h the data 7a received from in7 and converted by the first conversion circuit 231 from the two's complement representation to the partial sign magnitude-representation.

In the cycle t1,
the first data distribution part 202
outputs to the data line 205b the data 8a received from in0 and converted by the first conversion circuit 231 from the two's complement representation to the partial sign magnitude-representation,
outputs to the data line 205c the data 9a received from in1 and converted by the first conversion circuit 231 from the two's complement representation to the partial sign magnitude-representation,
outputs to the data line 205d the data 10a received from in2 and converted by the first conversion circuit 231 from the two's complement representation to the partial sign magnitude-representation,
outputs to the data line 205e the data 11a received from in3 and converted by the first conversion circuit 231 from the two's complement representation to the partial sign magnitude-representation,
outputs to the data line 205f the data 12a received from in4 and converted by the first conversion circuit 231 from the two's complement representation to the partial sign magnitude-representation,
outputs to the data line 205g the data 13a received from in5 and converted by the first conversion circuit 231 from the two's complement representation to the partial sign magnitude-representation,
outputs to the data line 205h the data 14a received from in6 and converted by the first conversion circuit 231 from the two's complement representation to the partial sign magnitude-representation, and
outputs to the data line 205a the data 15a received from in7 and converted by the first conversion circuit 231 from the two's complement representation to the partial sign magnitude-representation.

In the cycle t2,
the first data distribution part 202
outputs to the data line 205c the data 16a received from in0 and converted by the first conversion circuit 231 from the two's complement representation to the partial sign magnitude-representation,
outputs to the data line 205d the data 17a received from in1 and converted by the first conversion circuit 231 from the two's complement representation to the partial sign magnitude-representation,
outputs to the data line 205e the data 18a received from in2 and converted by the first conversion circuit 231 from the two's complement representation to the partial sign magnitude-representation,
outputs to the data line 205f the data 19a received from in3 and converted by the first conversion circuit 231 from the two's complement representation to the partial sign magnitude-representation,
outputs to the data line 205g the data 20a received from in4 and converted by the first conversion circuit 231 from the two's complement representation to the partial sign magnitude-representation,
outputs to the data line 205h the data 21a received from in5 and converted by the first conversion circuit 231 from the two's complement representation to the partial sign magnitude-representation,
outputs to the data line 205a the data 22a received from in6 and converted by the first conversion circuit 231 from the two's complement representation to the partial sign magnitude-representation, and
outputs to the data line 205b the data 23a received from in7 and converted by the first conversion circuit 231 from the two's complement representation to the partial sign magnitude-representation.

In the cycle t3,
the first data distribution part 202
outputs to the data line 205d the data 24a received from in0 and converted by the first conversion circuit 231 from the two's complement representation to the partial sign magnitude-representation,
outputs to the data line 205e the data 25a received from in1 and converted by the first conversion circuit 231 from the two's complement representation to the partial sign magnitude-representation,
outputs to the data line 205f the data 26a received from in2 and converted by the first conversion circuit 231 from the two's complement representation to the partial sign magnitude-representation,
outputs to the data line 205g the data 27a received from in3 and converted by the first conversion circuit 231 from the two's complement representation to the partial sign magnitude-representation,
outputs to the data line 205h the data 28a received from in4 and converted by the first conversion circuit 231 from the two's complement representation to the partial sign magnitude-representation,
outputs to the data line 205a the data 29a received from in5 and converted by the first conversion circuit 231 from the two's complement representation to the partial sign magnitude-representation,
outputs to the data line 205b the data 30a received from in6 and converted by the first conversion circuit 231 from the two's complement representation to the partial sign magnitude-representation, and
outputs to the data line 205c the data 31a received from in7 and converted by the first conversion circuit 231 from the two's complement representation to the partial sign magnitude-representation.

In the cycle t4,
the first data distribution part 202
outputs to the data line 205e the data 32a received from in0 and converted by the first conversion circuit 231 from the two's complement representation to the partial sign magnitude-representation,
outputs to the data line 205f the data 33a received from in1 and converted by the first conversion circuit 231 from the two's complement representation to the partial sign magnitude-representation,
outputs to the data line 205g the data 34a received from in2 and converted by the first conversion circuit 231 from the two's complement representation to the partial sign magnitude-representation,
outputs to the data line 205h the data 35a received from in3 and converted by the first conversion circuit 231 from the two's complement representation to the partial sign magnitude-representation,
outputs to the data line 205a the data 36a received from in4 and converted by the first conversion circuit 231 from the two's complement representation to the partial sign magnitude-representation,
outputs to the data line 205b the data 37a received from in5 and converted by the first conversion circuit 231 from the two's complement representation to the partial sign magnitude-representation,
outputs to the data line 205c the data 38a received from in6 and converted by the first conversion circuit 231 from the two's complement representation to the partial sign magnitude-representation, and
outputs to the data line 205d the data 39a received from in7 and converted by the first conversion circuit 231 from the two's complement representation to the partial sign magnitude-representation.

In the cycle t5,
the first data distribution part 202
outputs to the data line 205f the data 40a received from in0 and converted by the first conversion circuit 231 from the two's complement representation to the partial sign magnitude-representation,
outputs to the data line 205g the data 41a received from in1 and converted by the first conversion circuit 231 from the two's complement representation to the partial sign magnitude-representation,
outputs to the data line 205h the data 42a received from in2 and converted by the first conversion circuit 231 from the two's complement representation to the partial sign magnitude-representation,
outputs to the data line 205a the data 43a received from in3 and converted by the first conversion circuit 231 from the two's complement representation to the partial sign magnitude-representation,
outputs to the data line 205b the data 44a received from in4 and converted by the first conversion circuit 231 from the two's complement representation to the partial sign magnitude-representation,
outputs to the data line 205c the data 45a received from in5 and converted by the first conversion circuit 231 from the two's complement representation to the partial sign magnitude-representation,
outputs to the data line 205d the data 46a received from in6 and converted by the first conversion circuit 231 from the two's complement representation to the partial sign magnitude-representation, and
outputs to the data line 205e the data 47a received from in7 and converted by the first conversion circuit 231 from the two's complement representation to the partial sign magnitude-representation.

In the cycle t6,
the first data distribution part 202
outputs to the data line 205g the data 48a received from in0 and converted by the first conversion circuit 231 from the two's complement representation to the partial sign magnitude-representation,
outputs to the data line 205h the data 49a received from in1 and converted by the first conversion circuit 231 from the two's complement representation to the partial sign magnitude-representation,
outputs to the data line 205a the data 50a received from in2 and converted by the first conversion circuit 231 from the two's complement representation to the partial sign magnitude-representation,
outputs to the data line 205b the data 51a received from in3 and converted by the first conversion circuit 231 from the two's complement representation to the partial sign magnitude-representation,
outputs to the data line 205c the data 52a received from in4 and converted by the first conversion circuit 231 from the two's complement representation to the partial sign magnitude-representation,
outputs to the data line 205d the data 53a received from in5 and converted by the first conversion circuit 231 from the two's complement representation to the partial sign magnitude-representation,
outputs to the data line 205e the data 54a received from in6 and converted by the first conversion circuit 231 from the two's complement representation to the partial sign magnitude-representation, and
outputs to the data line 205f the data 55a received from in7 and converted by the first conversion circuit 231 from the two's complement representation to the partial sign magnitude-representation.

In the cycle t7,
the first data distribution part 202
outputs to the data line 205h the data 56a received from in0 and converted by the first conversion circuit 231 from the two's complement representation to the partial sign magnitude-representation,
outputs to the data line 205a the data 57a received from in1 and converted by the first conversion circuit 231 from the two's complement representation to the partial sign magnitude-representation,
outputs to the data line 205b the data 58a received from in2 and converted by the first conversion circuit 231 from the two's complement representation to the partial sign magnitude-representation,
outputs to the data line 205c the data 59a received from in3 and converted by the first conversion circuit 231 from the two's complement representation to the partial sign magnitude-representation,
outputs to the data line 205d the data 60a received from in4 and converted by the first conversion circuit 231 from the two's complement representation to the partial sign magnitude-representation,
outputs to the data line 205e the data 61a received from in5 and converted by the first conversion circuit 231 from the two's complement representation to the partial sign magnitude-representation,
outputs to the data line 205f the data 62a received from in6 and converted by the first conversion circuit 231 from the two's complement representation to the partial sign magnitude-representation, and
outputs to the data line 205g the data 63a received from in7 and converted by the first conversion circuit 231 from the two's complement representation to the partial sign magnitude-representation.

As described above, the first data distribution part 202 performs rotation processing on eight pieces of data simultaneously received in parallel and outputs the results. It may be easily realized by, for example, a shift circuit.

Likewise, the first data distribution part 202 performs assignment operation on:
the data 0b to 63b in the cycles t9 to t15, and
the data 0c to 63c in the cycles t16 to t23.

The next describes read and write operations of the write address control part 212, the read address control part 213, and the RAM circuits 210a to 210h controlled thereby.

The write address control part 212 and the read address control part 213 operate by referring to the operation mode 201. Here, the operation mode 201 is a control signal provided by a higher-level control circuit (not shown in the drawing) such as a CPU (Central Processing Unit) and is either a first or a second operation mode.

The operation mode 201 indicates the same operation mode for eight consecutive cycles in which data for the number of points in a 64-point FFT is supplied and indicates a different operation mode every eight cycles.

More specifically, in FIG. 15, the operation mode 201 indicates operation mode 0, which is the first operation mode, in the eight cycles t0 to t7 in which the data 0a to 63a are supplied.

The operation mode 201 indicates operation mode 1, which is the second operation mode, in the eight cycles t8 to t15 in which the data 0b to 63b are supplied. In the eight cycles t8 to t15 in the operation mode 1 (the second operation mode), data are read from the RAM circuits 210a to 210h to which data are written in the eight cycles t0 to t7 in the operation mode 0 (the first operation mode).

The operation mode 201 indicates the operation mode 0 (the first operation mode) again in the eight cycles t16 to t23 in which the data 0c to 63c are supplied. In the eight cycles t16 to t23, in which the data 0c to 63c are supplied, in the operation mode 0 (the first operation mode), data are read from the RAM circuits 210a to 210h to which data are written in the eight cycles t8 to t15 in the operation mode 1 (the second operation mode).

The operation mode 201 is a signal that alternately indicates the operation mode 0 or the operation mode 1 every eight cycles thereafter.

The write address control part 212 generates a write address according to a first address order when the operation mode 201 is the operation mode 0 (the first operation mode).

The write address control part 212 generates a write address according to a second address order when the operation mode 201 is the operation mode 1 (the second operation mode).

The first address order is an address order that always specifies a different address for each of the RAM circuits 210a to 210h. In other words, in the first operation mode, different addresses from each other are always outputted to the address lines 207a to 207h.

The second address order is an address order that always specifies the same address for each of the RAM circuits 210a to 210h. In other words, in the second operation mode, the same address is always outputted to the address lines 207a to 207h.

The read address control part 213 operates in the same manner as the write address control part 212. In other words, the read address control part 213 generates a read address (different address) for each of the RAM circuits 210a to 210h according to the first address order when the operation mode 201 is the operation mode 0 (the first operation mode). The read address control part 213 generates a read address (the same address) for each of the RAM circuits 210a to 210h according to the second address order when the operation mode 201 is the operation mode 1 (the second operation mode).

With reference to FIG. 15, the following describes a concrete example of read and write operations of the write address control part 212, the read address control part 213, and the RAM circuits 210a to 210h.

First,
in the eight cycles t0 to t7, the data 0a to 63a are written to the RAM circuits 210a to 210h.
In the eight cycles t8 to t15, the data 0a to 63a written in the RAM circuits 210a to 210h are read while the data 0b to 63b are written to the RAM circuits 210a to 210h.
In the eight cycles t16 to t23, the data 0b to 63b written in the RAM circuits 210a to 210h are read while the data 0c to 63c are written to the RAM circuits 210a to 210h. Note that, although data written in previous eight cycles before t0 to t7 are read in the eight cycles t0 to t7, this is not shown in the drawing.
As is evident from FIG. 15, read and write operations of the RAM circuits 210a to 210h are always performed on the same address in the same cycle. The RAM circuits 210a to 210h prioritize reading when both writing and reading occur at the same address simultaneously. Therefore, in the RAM circuits 210a to 210h, the data 0b to 63b are written after the data 0a to 63a have been read in each of the cycles t8 to t15.
Likewise, in each of the cycles t16 to t23, the data 0c to 63c are written after the data 0b to 63b have been read.

The next describes in detail write operations of the write address control part 212 and the RAM circuits 210a to 210h controlled thereby in the cycles t0 to t7.

With reference to FIG. 15,
in the eight cycles t0 to t7, the operation mode 201 indicates the operation mode 0 (the first operation mode), and the write address control part 212 generates write addresses according to the first address order.

The RAM circuits 210a to 210h write data outputted to 207a to 207h by the first data distribution part 202 to the write addresses generated by the write address control part 212.

More specifically,
in the cycle t0,
the RAM circuit 210a writes the data 0a to an address 0 outputted to the address line 207a by the write address control part 212,
the RAM circuit 210b writes the data 1a to an address 1 outputted to the address line 207b by the write address control part 212,
the RAM circuit 210c writes the data 2a to an address 2 outputted to the address line 207c by the write address control part 212,
the RAM circuit 210d writes the data 3a to an address 3 outputted to the address line 207d by the write address control part 212,
the RAM circuit 210e writes the data 4a to an address 4 outputted to the address line 207e by the write address control part 212,
the RAM circuit 210f writes the data 5a to an address 5 outputted to the address line 207f by the write address control part 212,
the RAM circuit 210g writes the data 6a to an address 6 outputted to the address line 207g by the write address control part 212, and
the RAM circuit 210h writes the data 7a to an address 7 outputted to the address line 207h by the write address control part 212.

In the cycle t1,
the RAM circuit 210a writes the data 15a to the address 7 outputted to the address line 207a by the write address control part 212,
the RAM circuit 210b writes the data 8a to the address 0 outputted to the address line 207b by the write address control part 212,
the RAM circuit 210c writes the data 9a to the address 1 outputted to the address line 207c by the write address control part 212,
the RAM circuit 210d writes the data 10a to the address 2 outputted to the address line 207d by the write address control part 212,
the RAM circuit 210e writes the data 11a to the address 3 outputted to the address line 207e by the write address control part 212,
the RAM circuit 210f writes the data 12a to the address 4 outputted to the address line 207f by the write address control part 212,
the RAM circuit 210g writes the data 13a to the address 5 outputted to the address line 207g by the write address control part 212, and
the RAM circuit 210h writes the data 14a to the address 6 outputted to the address line 207h by the write address control part 212.

In the cycle t2,
the RAM circuit 210a writes the data 22a to the address 6 outputted to the address line 207a by the write address control part 212,
the RAM circuit 210b writes the data 23a to the address 7 outputted to the address line 207b by the write address control part 212,
the RAM circuit 210c writes the data 16a to the address 0 outputted to the address line 207c by the write address control part 212,
the RAM circuit 210d writes the data 17a to the address 1 outputted to the address line 207d by the write address control part 212,
the RAM circuit 210e writes the data 18a to the address 2 outputted to the address line 207e by the write address control part 212,
the RAM circuit 210f writes the data 19a to the address 3 outputted to the address line 207f by the write address control part 212,
the RAM circuit 210g writes the data 20a to the address 4 outputted to the address line 207g by the write address control part 212, and
the RAM circuit 210h writes the data 21a to the address 5 outputted to the address line 207h by the write address control part 212.

In the cycle t3,
the RAM circuit 210a writes the data 29a to the address 5 outputted to the address line 207a by the write address control part 212,
the RAM circuit 210b writes the data 30a to the address 6 outputted to the address line 207b by the write address control part 212,
the RAM circuit 210c writes the data 31a to the address 7 outputted to the address line 207c by the write address control part 212,
the RAM circuit 210d writes the data 24a to the address 0 outputted to the address line 207d by the write address control part 212,
the RAM circuit 210e writes the data 25a to the address 1 outputted to the address line 207e by the write address control part 212,
the RAM circuit 210f writes the data 26a to the address 2 outputted to the address line 207f by the write address control part 212,
the RAM circuit 210g writes the data 27a to the address 3 outputted to the address line 207g by the write address control part 212, and
the RAM circuit 210h writes the data 28a to the address 4 outputted to the address line 207h by the write address control part 212.

In the cycle t4,
the RAM circuit 210a writes the data 36a to the address 4 outputted to the address line 207a by the write address control part 212,
the RAM circuit 210b writes the data 37a to the address 5 outputted to the address line 207b by the write address control part 212,
the RAM circuit 210c writes the data 38a to the address 6 outputted to the address line 207c by the write address control part 212,
the RAM circuit 210d writes the data 39a to the address 7 outputted to the address line 207d by the write address control part 212,
the RAM circuit 210e writes the data 32a to the address 0 outputted to the address line 207e by the write address control part 212,
the RAM circuit 210f writes the data 33a to the address 1 outputted to the address line 207f by the write address control part 212,
the RAM circuit 210g writes the data 34a to the address 2 outputted to the address line 207g by the write address control part 212, and
the RAM circuit 210h writes the data 35a to the address 3 outputted to the address line 207h by the write address control part 212.

In the cycle t5,
the RAM circuit 210a writes the data 43a to the address 3 outputted to the address line 207a by the write address control part 212,
the RAM circuit 210b writes the data 44a to the address 4 outputted to the address line 207b by the write address control part 212,
the RAM circuit 210c writes the data 45a to the address 5 outputted to the address line 207c by the write address control part 212,
the RAM circuit 210d writes the data 46a to the address 6 outputted to the address line 207d by the write address control part 212,
the RAM circuit 210e writes the data 47a to the address 7 outputted to the address line 207e by the write address control part 212,
the RAM circuit 210f writes the data 40a to the address 0 outputted to the address line 207f by the write address control part 212,
the RAM circuit 210g writes the data 41a to the address 1 outputted to the address line 207g by the write address control part 212, and
the RAM circuit 210h writes the data 42a to the address 2 outputted to the address line 207h by the write address control part 212.

In the cycle t6,
the RAM circuit 210a writes the data 50a to the address 2 outputted to the address line 207a by the write address control part 212,
the RAM circuit 210b writes the data 51a to the address 3 outputted to the address line 207b by the write address control part 212,
the RAM circuit 210c writes the data 52a to the address 4 outputted to the address line 207c by the write address control part 212,
the RAM circuit 210d writes the data 53a to the address 5 outputted to the address line 207d by the write address control part 212,
the RAM circuit 210e writes the data 54a to the address 6 outputted to the address line 207e by the write address control part 212,
the RAM circuit 210f writes the data 55a to the address 7 outputted to the address line 207f by the write address control part 212,
the RAM circuit 210g writes the data 48a to the address 0 outputted to the address line 207g by the write address control part 212, and
the RAM circuit 210h writes the data 49a to the address 1 outputted to the address line 207h by the write address control part 212.

In the cycle t7,
the RAM circuit 210a writes the data 57a to the address 1 outputted to the address line 207a by the write address control part 212,
the RAM circuit 210b writes the data 58a to the address 2 outputted to the address line 207b by the write address control part 212,
the RAM circuit 210c writes the data 59a to the address 3 outputted to the address line 207c by the write address control part 212,
the RAM circuit 210d writes the data 60a to the address 4 outputted to the address line 207d by the write address control part 212,
the RAM circuit 210e writes the data 61a to the address 5 outputted to the address line 207e by the write address control part 212,
the RAM circuit 210f writes the data 62a to the address 6 outputted to the address line 207f by the write address control part 212,
the RAM circuit 210g writes the data 63a to the address 7 outputted to the address line 207g by the write address control part 212, and
the RAM circuit 210h writes the data 56a to the address 0 outputted to the address line 207h by the write address control part 212.

As described above, in the first address order, addresses different from each other are outputted to the address lines 207a to 207h that specify the write addresses of the RAM circuits 210a to 210h.

In each of the cycles t0 to t7, a different address is outputted to each of the address lines 207a to 207h. For instance, different addresses, the addresses 0 to 7, are outputted to the address line 207a in the cycles t0 to t7.

The next describes a concrete example of read operations of the read address control part 213 and the RAM circuits 210a to 210h controlled thereby in the cycles t8 to t15.

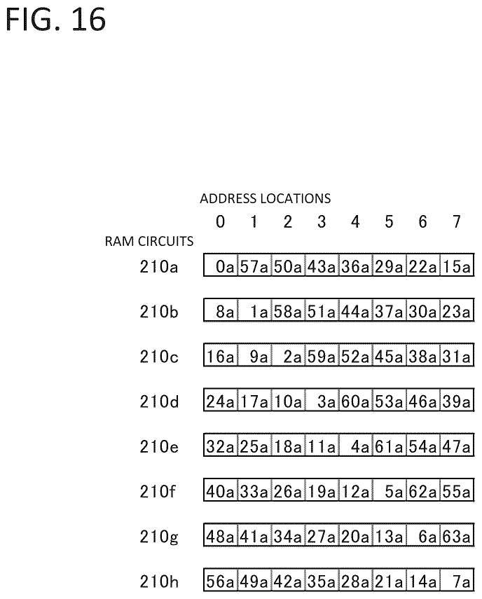

As a result of the write operations in the cycles t0 to t7, at the time of the cycle t8, the RAM circuits 210a to 210h store the data 0a to 63a, as shown in FIG. 16.

In the eight cycles t8 to t15, the operation mode 201 indicates the operation mode 1 (the second operation mode), and the read address control part 213 generates read addresses according to the second address order. The RAM circuits 210a to 210h output the stored data to the data lines 206a to 206h from the read addresses generated by the read address control part 213.

More specifically,
in the cycle t8,
the read address control part 213 outputs the address 0 to all the address lines 208a to 208h,
the RAM circuit 210a reads the data 0a from the address 0,
the RAM circuit 210b reads the data 8a from the address 0,
the RAM circuit 210c reads the data 16a from the address 0,
the RAM circuit 210d reads the data 24a from the address 0,
the RAM circuit 210e reads the data 32a from the address 0,
the RAM circuit 210f reads the data 40a from the address 0,
the RAM circuit 210g reads the data 48a from the address 0, and
the RAM circuit 210h reads the data 56a from the address 0.

In the cycle t9,
the read address control part 213 outputs the address 1 to all the address lines 208a to 208h,
the RAM circuit 210a reads the data 57a from the address 1,
the RAM circuit 210b reads the data 1a from the address 1,
the RAM circuit 210c reads the data 9a from the address 1,
the RAM circuit 210d reads the data 17a from the address 1,
the RAM circuit 210e reads the data 25a from the address 1,
the RAM circuit 210f reads the data 33a from the address 1,
the RAM circuit 210g reads the data 41a from the address 1, and
the RAM circuit 210h reads the data 49a from the address 1.

In the cycle t10,
the read address control part 213 outputs the address 2 to all the address lines 208a to 208h,
the RAM circuit 210a reads the data 50a from the address 2,
the RAM circuit 210b reads the data 58a from the address 2,
the RAM circuit 210c reads the data 2a from the address 2,
the RAM circuit 210d reads the data 10a from the address 2,
the RAM circuit 210e reads the data 18a from the address 2,
the RAM circuit 210f reads the data 26a from the address 2,
the RAM circuit 210g reads the data 34a from the address 2, and
the RAM circuit 210h reads the data 42a from the address 2.

In the cycle t1l,
the read address control part 213 outputs the address 3 to all the address lines 208a to 208h,
the RAM circuit 210a reads the data 43a from the address 3,
the RAM circuit 210b reads the data 51a from the address 3,
the RAM circuit 210c reads the data 59a from the address 3,
the RAM circuit 210d reads the data 3a from the address 3,
the RAM circuit 210e reads the data 11a from the address 3,
the RAM circuit 210f reads the data 19a from the address 3,
the RAM circuit 210g reads the data 27a from the address 3, and
the RAM circuit 210h reads the data 35a from the address 3.

In the cycle t12,
the read address control part 213 outputs the address 4 to all the address lines 208a to 208h,
the RAM circuit 210a reads the data 36a from the address 4,
the RAM circuit 210b reads the data 44a from the address 4,
the RAM circuit 210c reads the data 52a from the address 4,
the RAM circuit 210d reads the data 60a from the address 4,
the RAM circuit 210e reads the data 4a from the address 4,
the RAM circuit 210f reads the data 12a from the address 4,
the RAM circuit 210g reads the data 20a from the address 4, and
the RAM circuit 210h reads the data 28a from the address 4.

In the cycle t13,
the read address control part 213 outputs the address 5 to all the address lines 208a to 208h,
the RAM circuit 210a reads the data 29a from the address 5,
the RAM circuit 210b reads the data 37a from the address 5,
the RAM circuit 210c reads the data 45a from the address 5,
the RAM circuit 210d reads the data 53a from the address 5,
the RAM circuit 210e reads the data 61a from the address 5,
the RAM circuit 210f reads the data 5a from the address 5,
the RAM circuit 210g reads the data 13a from the address 5, and
the RAM circuit 210h reads the data 21a from the address 5.

In the cycle t14,
the read address control part 213 outputs the address 6 to all the address lines 208a to 208h,
the RAM circuit 210a reads the data 22a from the address 6,
the RAM circuit 210b reads the data 30a from the address 6,
the RAM circuit 210c reads the data 38a from the address 6,
the RAM circuit 210d reads the data 46a from the address 6,
the RAM circuit 210e reads the data 54a from the address 6,
the RAM circuit 210f reads the data 62a from the address 6,
the RAM circuit 210g reads the data 6a from the address 6, and
the RAM circuit 210h reads the data 14a from the address 6.

In the cycle t15,
the read address control part 213 outputs the address 7 to all the address lines 208a to 208h,
the RAM circuit 210a reads the data 15a from the address 7,
the RAM circuit 210b reads the data 23a from the address 7,
the RAM circuit 210c reads the data 31a from the address 7,
the RAM circuit 210d reads the data 39a from the address 7,
the RAM circuit 210e reads the data 47a from the address 7,
the RAM circuit 210f reads the data 55a from the address 7,
the RAM circuit 210g reads the data 63a from the address 7, and
the RAM circuit 210h reads the data 7a from the address 7.

As described above, in the second address order, the same address is outputted to all the address lines 208a to 208h that specify the read addresses of the RAM circuits 210a to 210h. In each of the cycles t8 to t15, a different address is outputted to each of the address lines 208a to 208h. For instance, different addresses, the addresses 0 to 7, are outputted to the address line 208a in the cycles t8 to t15.

The next describes a concrete example of write operations of the write address control part 212 and the RAM circuits 210a to 210h controlled thereby in the cycles t8 to t15.

In the eight cycles t8 to t15, the operation mode 201 indicates the operation mode 1 (the second operation mode), and the write address control part 212 generates write addresses according to the second address order.

The RAM circuits 210a to 210h write data outputted to the data lines 205a to 205h by the first data distribution part 202 to the write addresses generated by the write address control part 212.

More specifically, in the cycle t8,
the write address control part 212 outputs the address 0 to all the address lines 207a to 207h,
the RAM circuit 210a writes the data 0b to the address 0,
the RAM circuit 210b writes the data 1b to the address 0,
the RAM circuit 210c writes the data 2b to the address 0,
the RAM circuit 210d writes the data 3b to the address 0,
the RAM circuit 210e writes the data 4b to the address 0,
the RAM circuit 210f writes the data 5b to the address 0,
the RAM circuit 210g writes the data 6b to the address 0, and
the RAM circuit 210h writes the data 7b to the address 0.

In the cycle t9,
the write address control part 212 outputs the address 1 to all the address lines 207a to 207h,
the RAM circuit 210a writes the data 15b to the address 1,
the RAM circuit 210b writes the data 8b to the address 1,
the RAM circuit 210c writes the data 9b to the address 1,
the RAM circuit 210d writes the data 10b to the address 1,
the RAM circuit 210e writes the data 11b to the address 1,
the RAM circuit 210f writes the data 12b to the address 1,
the RAM circuit 210g writes the data 13b to the address 1, and
the RAM circuit 210h writes the data 14b to the address 1.

In the cycle t10,
the write address control part 212 outputs the address 2 to all the address lines 207a to 207h,
the RAM circuit 210a writes the data 22b to the address 2,
the RAM circuit 210b writes the data 23b to the address 2,
the RAM circuit 210c writes the data 16b to the address 2,
the RAM circuit 210d writes the data 17b to the address 2,
the RAM circuit 210e writes the data 18b to the address 2,
the RAM circuit 210f writes the data 19b to the address 2,
the RAM circuit 210g writes the data 20b to the address 2, and
the RAM circuit 210h writes the data 21b to the address 2.

In the cycle t1l,
the write address control part 212 outputs the address 3 to all the address lines 207a to 207h,
the RAM circuit 210a writes the data 29b to the address 3,
the RAM circuit 210b writes the data 30b to the address 3,
the RAM circuit 210c writes the data 31b to the address 3,
the RAM circuit 210d writes the data 24b to the address 3,
the RAM circuit 210e writes the data 25b to the address 3,
the RAM circuit 210f writes the data 26b to the address 3,
the RAM circuit 210g writes the data 27b to the address 3, and
the RAM circuit 210h writes the data 28b to the address 3.

In the cycle t12, the write address control part 212 outputs the address 4 to all the address lines 207a to 207h,
the RAM circuit 210a writes the data 36b to the address 4,
the RAM circuit 210b writes the data 37b to the address 4,
the RAM circuit 210c writes the data 38b to the address 4,
the RAM circuit 210d writes the data 39b to the address 4,
the RAM circuit 210e writes the data 32b to the address 4,
the RAM circuit 210f writes the data 33b to the address 4,
the RAM circuit 210g writes the data 34b to the address 4, and
the RAM circuit 210h writes the data 35b to the address 4.

In the cycle t13,
the write address control part 212 outputs the address 5 to all the address lines 207a to 207h,
the RAM circuit 210a writes the data 43b to the address 5,
the RAM circuit 210b writes the data 44b to the address 5,
the RAM circuit 210c writes the data 45b to the address 5,
the RAM circuit 210d writes the data 46b to the address 5,
the RAM circuit 210e writes the data 47b to the address 5,
the RAM circuit 210f writes the data 40b to the address 5,
the RAM circuit 210g writes the data 41b to the address 5, and
the RAM circuit 210h writes the data 42b to the address 5.

In the cycle t14,
the write address control part 212 outputs the address 6 to all the address lines 207a to 207h,
the RAM circuit 210a writes the data 50b to the address 6,
the RAM circuit 210b writes the data 51b to the address 6,
the RAM circuit 210c writes the data 52b to the address 6,
the RAM circuit 210d writes the data 53b to the address 6,
the RAM circuit 210e writes the data 54b to the address 6,
the RAM circuit 210f writes the data 55b to the address 6,
the RAM circuit 210g writes the data 48b to the address 6, and
the RAM circuit 210h writes the data 49b to the address 6.

In the cycle t15,
the write address control part 212 outputs the address 7 to all the address lines 207a to 207h,
the RAM circuit 210a writes the data 57b to the address 7,
the RAM circuit 210b writes the data 58b to the address 7,
the RAM circuit 210c writes the data 59b to the address 7,
the RAM circuit 210d writes the data 60b to the address 7,
the RAM circuit 210e writes the data 61b to the address 7,
the RAM circuit 210f writes the data 62b to the address 7,
the RAM circuit 210g writes the data 63b to the address 7, and
the RAM circuit 210h writes the data 56b to the address 7.

As described above, in the second address order, the same address is outputted to all the address lines 207a to 207h that specify the write addresses of the RAM circuits 210a to 210h.

In each of the cycles t8 to t15, a different address is outputted to each of the address lines 207a to 207h. For instance, different addresses, the addresses 0 to 7, are outputted to the address line 207a in the cycles t0 to t7.

The next describes a concrete example of read operations of the read address control part 213 and the RAM circuits 210a to 210h controlled thereby in the cycles t16 to t23.

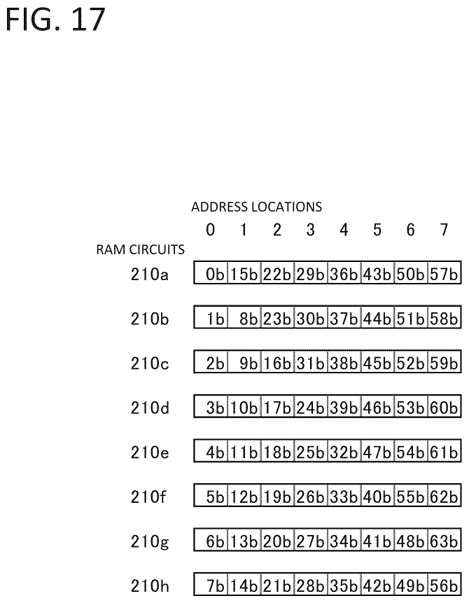

As a result of the write operations in the cycles t8 to t15, at the time of the cycle t16, the RAM circuits 210a to 210h store the data 0b to 63b, as shown in FIG. 17.

In the eight cycles t16 to t23, the operation mode 201 indicates the operation mode 0 (the first operation mode), and the read address control part 213 generates read addresses according to the first address order. The RAM circuits 210a to 210h output the stored data to the data lines 206a to 206h from the read addresses generated by the read address control part 213.

More specifically, in the cycle t16,
the RAM circuit 210a reads the data 0b from the address 0 outputted to the address line 208a by the read address control part 213,
the RAM circuit 210b reads the data 8b from the address 1 outputted to the address line 208b by the read address control part 213,
the RAM circuit 210c reads the data 16b from the address 2 outputted to the address line 208c by the read address control part 213,
the RAM circuit 210d reads the data 24b from the address 3 outputted to the address line 208d by the read address control part 213,
the RAM circuit 210e reads the data 32b from the address 4 outputted to the address line 208e by the read address control part 213,
the RAM circuit 210f reads the data 40b from the address 5 outputted to the address line 208f by the read address control part 213,
the RAM circuit 210g reads the data 48b from the address 6 outputted to the address line 208g by the read address control part 213, and
the RAM circuit 210h reads the data 56b from the address 7 outputted to the address line 208h by the read address control part 213.

In the cycle t17,
the RAM circuit 210a reads the data 57b from the address 7 outputted to the address line 208a by the read address control part 213,
the RAM circuit 210b reads the data 1b from the address 0 outputted to the address line 208b by the read address control part 213,
the RAM circuit 210c reads the data 9b from the address 1 outputted to the address line 208c by the read address control part 213,
the RAM circuit 210d reads the data 17b from the address 2 outputted to the address line 208d by the read address control part 213,
the RAM circuit 210e reads the data 25b from the address 3 outputted to the address line 208e by the read address control part 213,
the RAM circuit 210f reads the data 33b from the address 4 outputted to the address line 208f by the read address control part 213,
the RAM circuit 210g reads the data 41b from the address 5 outputted to the address line 208g by the read address control part 213, and
the RAM circuit 210h reads the data 49b from the address 6 outputted to the address line 208h by the read address control part 213.

In the cycle t18,
the RAM circuit 210a reads the data 50b from the address 6 outputted to the address line 208a by the read address control part 213,
the RAM circuit 210b reads the data 58b from the address 7 outputted to the address line 208b by the read address control part 213,
the RAM circuit 210c reads the data 2b from the address 0 outputted to the address line 208c by the read address control part 213,
the RAM circuit 210d reads the data 10b from the address 1 outputted to the address line 208d by the read address control part 213,
the RAM circuit 210e reads the data 18b from the address 2 outputted to the address line 208e by the read address control part 213,
the RAM circuit 210f reads the data 26b from the address 3 outputted to the address line 208f by the read address control part 213,
the RAM circuit 210g reads the data 34b from the address 4 outputted to the address line 208g by the read address control part 213, and
the RAM circuit 210h reads the data 42b from the address 5 outputted to the address line 208h by the read address control part 213.

In the cycle t19,
the RAM circuit 210a reads the data 43b from the address 5 outputted to the address line 208a by the read address control part 213,
the RAM circuit 210b reads the data 51b from the address 6 outputted to the address line 208b by the read address control part 213,
the RAM circuit 210c reads the data 59b from the address 7 outputted to the address line 208c by the read address control part 213,
the RAM circuit 210d reads the data 3b from the address 0 outputted to the address line 208d by the read address control part 213,
the RAM circuit 210e reads the data 11b from the address 1 outputted to the address line 208e by the read address control part 213,
the RAM circuit 210f reads the data 19b from the address 2 outputted to the address line 208f by the read address control part 213,
the RAM circuit 210g reads the data 27b from the address 3 outputted to the address line 208g by the read address control part 213, and
the RAM circuit 210h reads the data 35b from the address 4 outputted to the address line 208h by the read address control part 213.

In the cycle t20,
the RAM circuit 210a reads the data 36b from the address 4 outputted to the address line 208a by the read address control part 213,
the RAM circuit 210b reads the data 44b from the address 5 outputted to the address line 208b by the read address control part 213,
the RAM circuit 210c reads the data 52b from the address 6 outputted to the address line 208c by the read address control part 213,
the RAM circuit 210d reads the data 60b from the address 7 outputted to the address line 208d by the read address control part 213,
the RAM circuit 210e reads the data 4b from the address 0 outputted to the address line 208e by the read address control part 213,
the RAM circuit 210f reads the data 12b from the address 1 outputted to the address line 208f by the read address control part 213,
the RAM circuit 210g reads the data 20b from the address 2 outputted to the address line 208g by the read address control part 213, and
the RAM circuit 210h reads the data 28b from the address 3 outputted to the address line 208h by the read address control part 213.

In the cycle t21,
the RAM circuit 210a reads the data 29b from the address 3 outputted to the address line 208a by the read address control part 213,
the RAM circuit 210b reads the data 37b from the address 4 outputted to the address line 208b by the read address control part 213,
the RAM circuit 210c reads the data 45b from the address 5 outputted to the address line 208c by the read address control part 213,
the RAM circuit 210d reads the data 53b from the address 6 outputted to the address line 208d by the read address control part 213,
the RAM circuit 210e reads the data 61b from the address 7 outputted to the address line 208e by the read address control part 213,
the RAM circuit 210f reads the data 5b from the address 0 outputted to the address line 208f by the read address control part 213,
the RAM circuit 210g reads the data 13b from the address 1 outputted to the address line 208g by the read address control part 213, and
the RAM circuit 210h reads the data 21b from the address 2 outputted to the address line 208h by the read address control part 213.

In the cycle t22,
the RAM circuit 210a reads the data 22b from the address 2 outputted to the address line 208a by the read address control part 213,
the RAM circuit 210b reads the data 30b from the address 3 outputted to the address line 208b by the read address control part 213,
the RAM circuit 210c reads the data 38b from the address 4 outputted to the address line 208c by the read address control part 213,
the RAM circuit 210d reads the data 46b from the address 5 outputted to the address line 208d by the read address control part 213,
the RAM circuit 210e reads the data 54b from the address 6 outputted to the address line 208e by the read address control part 213,
the RAM circuit 210f reads the data 62b from the address 7 outputted to the address line 208f by the read address control part 213,
the RAM circuit 210g reads the data 6b from the address 0 outputted to the address line 208g by the read address control part 213, and
the RAM circuit 210h reads the data 14b from the address 1 outputted to the address line 208h by the read address control part 213.

In the cycle t23,
the RAM circuit 210a reads the data 15b from the address 1 outputted to the address line 208a by the read address control part 213,
the RAM circuit 210b reads the data 23b from the address 2 outputted to the address line 208b by the read address control part 213,
the RAM circuit 210c reads the data 31b from the address 3 outputted to the address line 208c by the read address control part 213,
the RAM circuit 210d reads the data 39b from the address 4 outputted to the address line 208d by the read address control part 213,
the RAM circuit 210e reads the data 47b from the address 5 outputted to the address line 208e by the read address control part 213,
the RAM circuit 210f reads the data 55b from the address 6 outputted to the address line 208f by the read address control part 213,
the RAM circuit 210g reads the data 63b from the address 7 outputted to the address line 208g by the read address control part 213, and
the RAM circuit 210h reads the data 7b from the address 0 outputted to the address line 208h by the read address control part 213.

As described above, in the first address order, addresses different from each other are outputted to the address lines 208a to 208h that specify the read addresses of the RAM circuits 210a to 210h.

In each of the cycles t16 to t23, a different address is outputted to each of the address lines 208a to 208h. For instance, different addresses, the addresses 0 to 7, are outputted to the address line 208a in the cycles t16 to t23.

The next describes an operation of the second data distribution part 203 in the cycles t8 to t15.

More specifically, in the cycle t8,
the data 0a received from the data line 206a is converted by the second conversion circuit 232 from the partial sign magnitude-representation to the two's complement representation and is outputted to out0,
the data 8a received from the data line 206b is converted by the second conversion circuit 232 from the partial sign magnitude-representation to the two's complement representation and is outputted to out1,
the data 16a received from the data line 206c is converted by the second conversion circuit 232 from the partial sign magnitude-representation to the two's complement representation and is outputted to out2,
the data 24a received from the data line 206d is converted by the second conversion circuit 232 from the partial sign magnitude-representation to the two's complement representation and is outputted to out3,
the data 32a received from the data line 206e is converted by the second conversion circuit 232 from the partial sign magnitude-representation to the two's complement representation and is outputted to out4,
the data 40a received from the data line 206f is converted by the second conversion circuit 232 from the partial sign magnitude-representation to the two's complement representation and is outputted to out5,
the data 48a received from the data line 206g is converted by the second conversion circuit 232 from the partial sign magnitude-representation to the two's complement representation and is outputted to out6, and
the data 56a received from the data line 206h is converted by the second conversion circuit 232 from the partial sign magnitude-representation to the two's complement representation and is outputted to out7.

In the cycle t9,
the data 57a received from the data line 206a is converted by the second conversion circuit 232 from the partial sign magnitude-representation to the two's complement representation and is outputted to out7,
the data 1a received from the data line 206b is converted by the second conversion circuit 232 from the partial sign magnitude-representation to the two's complement representation and is outputted to out0,
the data 9a received from the data line 206c is converted by the second conversion circuit 232 from the partial sign magnitude-representation to the two's complement representation and is outputted to out1,
the data 17a received from the data line 206d is converted by the second conversion circuit 232 from the partial sign magnitude-representation to the two's complement representation and is outputted to out2,
the data 25a received from the data line 206e is converted by the second conversion circuit 232 from the partial sign magnitude-representation to the two's complement representation and is outputted to out3,
the data 33a received from the data line 206f is converted by the second conversion circuit 232 from the partial sign magnitude-representation to the two's complement representation and is outputted to out4,
the data 41a received from the data line 206g is converted by the second conversion circuit 232 from the partial sign magnitude-representation to the two's complement representation and is outputted to out5, and
the data 49a received from the data line 206h is converted by the second conversion circuit 232 from the partial sign magnitude-representation to the two's complement representation and is outputted to out6.

In the cycle t10,
the data 50a received from the data line 206a is converted by the second conversion circuit 232 from the partial sign magnitude-representation to the two's complement representation and is outputted to out6,
the data 58a received from the data line 206b is converted by the second conversion circuit 232 from the partial sign magnitude-representation to the two's complement representation and is outputted to out7,
the data 2a received from the data line 206c is converted by the second conversion circuit 232 from the partial sign magnitude-representation to the two's complement representation and is outputted to out0,
the data 10a received from the data line 206d is converted by the second conversion circuit 232 from the partial sign magnitude-representation to the two's complement representation and is outputted to out1,
the data 18a received from the data line 206e is converted by the second conversion circuit 232 from the partial sign magnitude-representation to the two's complement representation and is outputted to out2,
the data 26a received from the data line 206f is converted by the second conversion circuit 232 from the partial sign magnitude-representation to the two's complement representation and is outputted to out3,
the data 34a received from the data line 206g is converted by the second conversion circuit 232 from the partial sign magnitude-representation to the two's complement representation and is outputted to out4, and
the data 42a received from the data line 206h is converted by the second conversion circuit 232 from the partial sign magnitude-representation to the two's complement representation and is outputted to out5.

In the cycle t11,
the data 43a received from the data line 206a is converted by the second conversion circuit 232 from the partial sign magnitude-representation to the two's complement representation and is outputted to out5,
the data 51a received from the data line 206b is converted by the second conversion circuit 232 from the partial sign magnitude-representation to the two's complement representation and is outputted to out6,
the data 59a received from the data line 206c is converted by the second conversion circuit 232 from the partial sign magnitude-representation to the two's complement representation and is outputted to out7,
the data 3a received from the data line 206d is converted by the second conversion circuit 232 from the partial sign magnitude-representation to the two's complement representation and is outputted to out0,
the data 11a received from the data line 206e is converted by the second conversion circuit 232 from the partial sign magnitude-representation to the two's complement representation and is outputted to out1,
the data 19a received from the data line 206f is converted by the second conversion circuit 232 from the partial sign magnitude-representation to the two's complement representation and is outputted to out2,
the data 27a received from the data line 206g is converted by the second conversion circuit 232 from the partial sign magnitude-representation to the two's complement representation and is outputted to out3, and
the data 35a received from the data line 206h is converted by the second conversion circuit 232 from the partial sign magnitude-representation to the two's complement representation and is outputted to out4.

In the cycle t12,
the data 36a received from the data line 206a is converted by the second conversion circuit 232 from the partial sign magnitude-representation to the two's complement representation and is outputted to out4,
the data 44a received from the data line 206b is converted by the second conversion circuit 232 from the partial sign magnitude-representation to the two's complement representation and is outputted to out5,
the data 52a received from the data line 206c is converted by the second conversion circuit 232 from the partial sign magnitude-representation to the two's complement representation and is outputted to out6,
the data 60a received from the data line 206d is converted by the second conversion circuit 232 from the partial sign magnitude-representation to the two's complement representation and is outputted to out7,
the data 4a received from the data line 206e is converted by the second conversion circuit 232 from the partial sign magnitude-representation to the two's complement representation and is outputted to out0,
the data 12a received from the data line 206f is converted by the second conversion circuit 232 from the partial sign magnitude-representation to the two's complement representation and is outputted to out1,
the data 20a received from the data line 206g is converted by the second conversion circuit 232 from the partial sign magnitude-representation to the two's complement representation and is outputted to out2, and
the data 28a received from the data line 206h is converted by the second conversion circuit 232 from the partial sign magnitude-representation to the two's complement representation and is outputted to out3.

In the cycle t13,
the data 29a received from the data line 206a is converted by the second conversion circuit 232 from the partial sign magnitude-representation to the two's complement representation and is outputted to out3,
the data 37a received from the data line 206b is converted by the second conversion circuit 232 from the partial sign magnitude-representation to the two's complement representation and is outputted to out4,
the data 45a received from the data line 206c is converted by the second conversion circuit 232 from the partial sign magnitude-representation to the two's complement representation and is outputted to out5,
the data 53a received from the data line 206d is converted by the second conversion circuit 232 from the partial sign magnitude-representation to the two's complement representation and is outputted to out6,
the data 61a received from the data line 206e is converted by the second conversion circuit 232 from the partial sign magnitude-representation to the two's complement representation and is outputted to out7,
the data 5a received from the data line 206f is converted by the second conversion circuit 232 from the partial sign magnitude-representation to the two's complement representation and is outputted to out0,
the data 13a received from the data line 206g is converted by the second conversion circuit 232 from the partial sign magnitude-representation to the two's complement representation and is outputted to out1, and
the data 21a received from the data line 206h is converted by the second conversion circuit 232 from the partial sign magnitude-representation to the two's complement representation and is outputted to out2.

In the cycle t14,
the data 22a received from the data line 206a is converted by the second conversion circuit 232 from the partial sign magnitude-representation to the two's complement representation and is outputted to out2,
the data 30a received from the data line 206b is converted by the second conversion circuit 232 from the partial sign magnitude-representation to the two's complement representation and is outputted to out3,
the data 38a received from the data line 206c is converted by the second conversion circuit 232 from the partial sign magnitude-representation to the two's complement representation and is outputted to out4,
the data 46a received from the data line 206d is converted by the second conversion circuit 232 from the partial sign magnitude-representation to the two's complement representation and is outputted to out5,
the data 54a received from the data line 206e is converted by the second conversion circuit 232 from the partial sign magnitude-representation to the two's complement representation and is outputted to out6,
the data 62a received from the data line 206f is converted by the second conversion circuit 232 from the partial sign magnitude-representation to the two's complement representation and is outputted to out7,
the data 6a received from the data line 206g is converted by the second conversion circuit 232 from the partial sign magnitude-representation to the two's complement representation and is outputted to out0, and
the data 14a received from the data line 206h is converted by the second conversion circuit 232 from the partial sign magnitude-representation to the two's complement representation and is outputted to out1.

In the cycle t15,
the data 15a received from the data line 206a is converted by the second conversion circuit 232 from the partial sign magnitude-representation to the two's complement representation and is outputted to out1,
the data 23a received from the data line 206b is converted by the second conversion circuit 232 from the partial sign magnitude-representation to the two's complement representation and is outputted to out2,
the data 31a received from the data line 206c is converted by the second conversion circuit 232 from the partial sign magnitude-representation to the two's complement representation and is outputted to out3,
the data 39a received from the data line 206d is converted by the second conversion circuit 232 from the partial sign magnitude-representation to the two's complement representation and is outputted to out4,
the data 47a received from the data line 206e is converted by the second conversion circuit 232 from the partial sign magnitude-representation to the two's complement representation and is outputted to out5,
the data 55a received from the data line 206f is converted by the second conversion circuit 232 from the partial sign magnitude-representation to the two's complement representation and is outputted to out6,
the data 63a received from the data line 206g is converted by the second conversion circuit 232 from the partial sign magnitude-representation to the two's complement representation and is outputted to out7, and
the data 7a received from the data line 206h is converted by the second conversion circuit 232 from the partial sign magnitude-representation to the two's complement representation and is outputted to out0.

As described above, as a result of the data distribution processing performed by the second data distribution part 203, the data 0a to 63a are outputted to out0 to out7 in the bit-reversed order in the cycles t8 to t15.

As the first data distribution part 202, the second data distribution part 203 performs rotation processing on eight pieces of data simultaneously received in parallel and outputs the results. It may be easily realized by, for example, a shift circuit.

The second data distribution part 203 also performs the same data distribution processing on the data 0b to 63b in the cycles t16 to t23, and the data 0b to 63b are outputted to out0 to out7 in the bit-reversed order.

While the data reordering processing has been described above using an example of reordering from the sequential order to the bit-reversed order, reordering from the bit-reversed order to the sequential order can also be achieved in the same manner.

As described above, in the present example embodiment, the data reordering processing part 200 of the FFT apparatus 30 achieves reordering from the “sequential order” to the “bit-reversed order” and reordering from the “bit-reversed order” to the “sequential order,” data reordering processing required in a butterfly operation, by controlling read and write operations of the RAM circuits 210a to 210h using two types of address orders, namely the first and the second address orders.

For instance, data written to the RAM circuits in the first address order are read in the second address order, and data written in the second address order are read in the first address order.

As a result, in the present example embodiment, even when FFT processing is performed on signals that are supplied continuously, data reordering processing can be achieved with a RAM circuit having a storage capacity equal to the number of FFT points.

Therefore, compared with double-buffering, which requires a storage capacity at least twice the number of FFT points for data reordering processing, the present disclosure reduces the storage capacity of the RAM circuit by half, thereby reducing the circuit scale and power consumption of the RAM circuit. As a result, the circuit scale and power consumption of the entire FFT apparatus including the data reordering processing part can be reduced.

In the present example embodiment, the FFT apparatus 30 reorders data from the “sequential order” to the “bit-reversed order” or from the “bit-reversed order” to the “sequential order,” which is data reordering processing required in a butterfly operation, after converting the data to the partial sign magnitude-representation. Therefore, as compared with a case where reordering processing is performed while keeping data in the two's complement representation, the percentage-activity of flip-flop circuits and selector circuits constituting the RAM circuits 210a to 210h, the first data distribution part 202, and the second data distribution part 203, can be reduced.

The conversion between the two's complement representation and the partial sign magnitude-representation can be achieved only with bit inversion processing and does not require add-one processing (increment processing) which is required in the case of the sign magnitude representation. Since a bit inversion circuit can be implemented only with an XOR circuit, this can be realized with an overwhelmingly small circuit scale, as compared with other logic processing circuits and operation processing circuits. As compared with conversion between the two's complement representation and the partial sign magnitude-representation, the number of required XOR circuits is smaller. As a result, this can be implemented with a smaller circuit scale.

Therefore, in the present example embodiment, even when processing a signal with a value which frequently changes between positive and negative in the vicinity of zero, it is possible to keep the circuit operation rate in data reordering processing to a minimum. As a result, the power consumption in the data reordering processing part can be reduced.

In the present example embodiment, the butterfly operation processing part and the twiddle factor multiplication processing part perform butterfly operation processing and twiddle factor multiplication processing in the two's complement representation. Therefore, the percentage-activity related to these arithmetic processes is not reduced. The conversion between the data representation formats, however, does not increase the circuit scale unlike in the case where the sign magnitude representation is applied.

Therefore, in the present example embodiment, the power consumption of the entire FFT apparatus can be reduced by the amount of the power consumption reduced in data reordering processing. Since the scale of the conversion circuit is smaller, compared to the case where the sign magnitude-representation is used, more conversion processes can be performed in more optimal locations. As a result, the power consumption of the entire FFT apparatus can be further reduced.

The several example embodiments above can be described as (but not limited to) the following Supplementary Notes (Notes).

(Note 1) A signal processing apparatus includes: an operation processing part configured to perform operation processing on D-bits data (where D is a positive integer greater than or equal to three) represented in a two's complement representation as a data representation format; and a storage processing part configured to perform storage processing on D-bits data represented in a second representation format as a data representation format, wherein
the second representation format for a non-negative value of the D-bits data is identical to the two's complement representation therefor, and
the second representation format for a negative value of the D-bits data has a representation format in which (D−N−1) bits of the D-bits data represented in the two's complement representation are bit-wise inverted (where N is a positive integer such that N≤D−2), wherein the (D−N−1) bits are remaining bits in the D-bits data obtained by excluding a most significant bit indicating a sign and N consecutive lower bits including a least significant bit therefrom.

(Note 2) The signal processing apparatus according to Note 1 includes a lower-bit mask circuit configured to:
receive the D-bits data as input;
set each of M lower bit or bits in the D-bits data to a predetermined fixed value, the M lower bit or bits including the least significant bit (M is a positive integer such that 1≤M≤N); and
output resulting D-bits data.

(Note 3) In the signal processing apparatus according to Note 1 or 2, the storage processing part includes a data reordering processing part configured to rearrange an order of a plurality of pieces of data supplied in a first order to a second order.

The data reordering processing part includes: a storage circuit; a first control circuit configured to write a plurality of pieces of data in parallel to the storage circuit in accordance with one of a first address order and a second address order; and a second control circuit configured to read in parallel from the storage circuit, the plurality of pieces of data that have been written to the storage circuit in accordance with the one of the first address order and the second address order, in accordance with other of the first address order and the second address order.

(Note 4) In the storage processing part of the signal processing apparatus according to Note 3, the storage circuit includes a plurality of storage elements that store the plurality of pieces of data for a plurality of cycles, a plurality of addresses simultaneously supplied to the plurality of storage elements are different from each other in the first address order, and a plurality of addresses simultaneously supplied to the plurality of storage elements are identical to each other in the second address order.

(Note 5) The signal processing apparatus according to Note 4, the operation processing part includes: a butterfly operation processing circuit, which may be implemented by a signal processor and/or a hardware circuit, configured to perform butterfly operation processing on the plurality of pieces of data; and a twiddle factor multiplication processing circuit, which may be implemented by a signal processor and/or a hardware circuit, configured to multiply the plurality of pieces of data by corresponding twiddle factors.

The storage processing part further includes: a first conversion circuit; a first data distribution circuit; a second data distribution circuit; and a second conversion circuit.

The first conversion circuit, which may be implemented by a signal processor and/or a hardware circuit, is configured to: receive a plurality of pieces of data represented in the two's complement representation; and convert the received plurality of pieces of data represented in the two's complement representation to a plurality of pieces of data represented in the second representation format for output.

The first data distribution circuit, which may be implemented by a signal processor and/or a hardware circuit, is configured to: receive the plurality of pieces of data represented in the second representation format outputted from the first conversion circuit; and perform data distribution processing of the received plurality of pieces of data for output, the plurality of pieces of data represented in the second representation format distributed and outputted by the first data distribution circuit being written to the plurality of storage elements using addresses outputted from the first control circuit.

The second data distribution circuit, which may be implemented by a signal processor and/or a hardware circuit, is configured to: receive the plurality of pieces of data represented in the second representation format read from the plurality of storage elements using addresses outputted from the second control circuit; and perform data distribution processing of the received plurality of pieces of data for output.

The second conversion circuit, which may be implemented by a signal processor and/or a hardware circuit, is configured to: receive the plurality of pieces of data represented in the second representation format distributed and outputted by the second data distribution circuit; and convert the received plurality of pieces of data represented in the second representation format to a plurality of pieces of data represented in the two's complement representation.

(Note 6) A signal processing apparatus, which may be implemented by a signal processor and/or a hardware circuit, and performs (n×n)-point fast Fourier transform or inverse fast Fourier transform, includes:
first to third data reordering processing circuits;
first and second butterfly operation processing circuits; and
a twiddle factor multiplication processing circuit that multiplies data by a twiddle factor.

The first data reordering processing circuit is configured to:
receive n pieces of data supplied in parallel in a sequential order for n cycles,
rearrange an order of the n pieces of data to a bit-reversed order; and
output in parallel the n pieces of data rearranged in the bit-reversed order, for n cycles.

The first butterfly operation processing circuit is configured to:
perform a butterfly operation on the n pieces of data outputted in parallel by the first data reordering processing circuit; and
output in parallel n pieces of data subjected to the butterfly operation.

The second data reordering processing circuit is configured to:
receive n pieces of data outputted in parallel in a sequential order by the first butterfly operation processing circuit for n cycles; and
rearrange an order of the data to the bit-reversed order; and outputs in parallel the n pieces of data rearranged in the bit-reversed order for n cycles.

The twiddle factor multiplication processing circuit is configured to:
multiply the n pieces of data outputted by the second data reordering processing circuit by corresponding twiddle factors,
wherein the second butterfly operation processing circuit is configured to:
perform a butterfly operation on the n pieces of data outputted by the twiddle factor multiplication processing circuit; and
output in parallel the n pieces of data subjected to the butterfly operation.

The third data reordering processing circuit is configured to:
receive the n pieces of data outputted in parallel in the bit-reversed order by the second butterfly operation processing circuit for the n cycles,
rearrange an order of the data into the sequential order; and
output in parallel the n pieces of data rearranged into the sequential order for n cycles.

The first and the second butterfly operation processing circuits and the twiddle factor multiplication processing circuit perform operation processing on the n pieces of data represented in the two's complement representation.

The first to the third data reordering processing circuits rearrange an order of the n pieces of data represented in the second representation format.

The second representation format for a non-negative value of the D-bits data is identical to the two's complement representation therefor, and the second representation format for a negative value of the D-bits data has a representation format in which (D−N−1) bits of the D-bits data represented in the two's complement representation are bit-wise inverted (where N is a positive integer such that N≤D−2), wherein the (D−N−1) bits are remaining bits in the D-bits data obtained by excluding a most significant bit indicating a sign and N consecutive lower bits including a least significant bit therefrom.

(Note 7) In the signal processing apparatus according to Note 6, each of the first to the third data reordering processing circuits includes:
a storage circuit includes n storage elements configured to store the n pieces of data, respectively, for each of n cycles;
a first control circuit configured to perform control to write the n pieces of data to the n storage elements, for n cycles, in accordance with one of a first address order and a second address order; and
a second control circuit configured to perform control to read from the n storage elements, in accordance with other of the first address order and the second address order, for n cycles, the n pieces of data written to the n storage elements in accordance with the one of the first address order and the second address order.

In the first address order, n addresses respectively supplied to the n storage elements in a cycle are different from each other, and in the second address order, the n addresses respectively supplied to the n storage elements in a cycle are identical to each other.

(Note 8) In the signal processing apparatus according to Note 7, the first and the second control circuits are configured to alternately switch between the first address order and the second address order, every n cycles.

(Note 9) In the signal processing apparatus according to any one of Notes 6 to 8, at least one of the first and the second butterfly operation processing circuits and the twiddle factor multiplication processing circuit includes a lower-bit mask circuit configured to set each of a second number lower bits of data (the second number is at least one and no greater than the first number) to a predetermined fixed value and outputs resulting data.

(Note 10) A signal processing method includes:
performing operation processing on D-bits data (D is a positive integer greater than or equal to three) represented in a two's complement representation as a data representation format; and
performing storage processing on D-bits data represented in a second representation format as a data representation format.

The second representation format for a non-negative value of the D-bits data is identical to the two's complement representation therefor, and the second representation format for a negative value of the D-bits data has a representation format in which (D−N−1) bits of the D-bits data represented in the two's complement representation are bit-wise inverted (where N is a positive integer such that N≤D−2), wherein the (D−N−1) bits are remaining bits in the D-bits data obtained by excluding a most significant bit indicating a sign and N consecutive lower bits including a least significant bit therefrom.

(Note 11) The signal processing method according to Note 10 includes receiving the D-bits data, setting each of M lower bit or bits including a least significant bit (M is a positive integer such that 1≤M≤N) to a predetermined fixed value, and outputting resulting data.

(Note 12) In the signal processing method according to Note 10 or 11, the storage processing includes
rearranging an order of a plurality of pieces of data supplied in a first order to a second order, and the data reordering processing includes
writing a plurality of pieces of data in parallel to the storage circuit in accordance with one of a first address order and a second address order; and
reading in parallel from the storage circuit, the plurality of pieces of data that have been written to the storage circuit in accordance with the one of the first address order and the second address order, in accordance with other of the first address order and the second address order.

(Note 13) In the signal processing method according to Note 12,
for a plurality of storage elements configured to store the plurality of pieces of data, for each of a plurality of cycles,
in the first address order, supplying, in a cycle, a plurality of addresses different from each other simultaneously to the plurality of storage elements in a cycle, and
in the second address order, supplying, in a cycle, a plurality of addresses identical to each other simultaneously to the plurality of storage elements.

(Note 14) In the signal processing method according to Note 13, the operation processing includes performing butterfly operation processing on the plurality of pieces of data; and performing twiddle factor multiplication processing on the plurality of pieces of data.

The storage processing includes: performing first conversion processing that receives a plurality of pieces of data represented in the two's complement representation and converts the received plurality of pieces of data in the two's complement representation to a plurality of pieces of data represented in the second representation format for output; first data distribution processing that receives the plurality of pieces of data represented in the second representation format outputted by the first conversion processing to perform data distribution processing thereon; and distributes the plurality of pieces of data represented in the second representation format for output, the plurality of pieces of data being written to the plurality of storage elements using one of the first address order and the second address order; second data distribution processing that receives the plurality of pieces of data represented in the second representation format read from the plurality of storage elements using the other of the first address order and the second address order to perform data distribution processing thereon; and performing second conversion processing that receives a plurality of pieces of data represented in the second representation format distributed by the second data distribution processing and converts the plurality of pieces of data represented in the second representation format to data in the two's complement representation to output a result.
[Reference Literature 1]
Japanese Patent Kokai Publication No. JP-H08-137832A (pp. 3-5, FIG. 25)
[Reference Literature 2]
J. W. Cooley, J. W. Tukey, “An Algorithm for the Machine Calculation of Complex Fourier Series,” Mathematics of Computation, US, American Mathematical Society, April 1965, Vol. 19, No. 90, pp. 297-301
[Reference Literature 3]
D. P. Kolba, “A Prime Factor FFT Algorithm Using High-Speed Convolution,” IEEE Trans. on Acoustics, US, IEEE Signal Processing Society, August 1977, Vol. 29, No. 4, pp. 281-294
[Reference Literature 4]
Japanese Patent Kokai Publication No. JP-P2001-56806A (p. 5, FIG. 1)

Each disclosure of Patent Literature 1 and Reference Literatures 1 to 4 cited above is incorporated herein in its entirety by reference thereto. It is to be noted that it is possible to modify or adjust the example embodiments or examples within the scope of the entirety of the present disclosure (including the Claims) and based on the basic technical concept thereof. Further, it is possible to variously combine or select a wide variety of the disclosed elements (including the individual elements of the individual claims, the individual elements of the individual examples, and the individual elements of the individual figures) within the scope of the Claims. That is, it is self-explanatory that the present disclosure includes any types of variations and modifications to be done by a person skilled in the art according to the whole disclosure, and the technical concept of the present disclosure.

What is claimed is:

1. A signal processing apparatus, comprising:
an operation processing part configured to perform operation processing on D-bits data (where D is a positive integer greater than or equal to three) represented in a two's complement representation as a data representation format; and
a storage processing part configured to perform storage processing on D-bits data represented in a second representation format as a data representation format,
wherein the second representation format for a non-negative value of the D-bits data is identical to the two's complement representation therefor, and
the second representation format for a negative value of the D-bits data has a representation format in which (D−N−1) bits of the D-bits data represented in the two's complement representation are bit-wise inverted (where N is a positive integer such that N≤D−2), wherein the (D−N−1) bits are remaining bits in the D-bits data obtained by excluding a most significant bit indicating a sign and N consecutive lower bits including a least significant bit therefrom.

2. The signal processing apparatus according to claim 1, further comprising
a lower-bit mask circuit configured to:
receive the D-bits data as input;
set each of M lower bit or bits in the D-bits data to a predetermined fixed value, the M lower bit or bits including the least significant bit (M is a positive integer such that 1≤M≤N); and
output resulting D-bits data.

3. The signal processing apparatus according to claim 1, wherein the storage processing part includes
a data reordering processing part configured to rearrange an order of a plurality of pieces of data supplied in a first order to a second order, the plurality of pieces of data each being D-bits,
wherein the data reordering processing part includes:
a storage circuit;
a first control circuit configured to write the plurality of pieces of data in parallel to the storage circuit in accordance with one of a first address order and a second address order; and
a second control circuit configured to read in parallel from the storage circuit, the plurality of pieces of data that have been written to the storage circuit in accordance with the one of the first address order and the second address order, in accordance with other of the first address order and the second address order.

4. The signal processing apparatus according to claim 3, wherein the storage circuit in the storage processing part includes
a plurality of storage elements configured to store the plurality of pieces of data, for each of a plurality of cycles,
wherein in the first address order, a plurality of addresses simultaneously supplied to the plurality of storage elements in a cycle are different from each other, and
in the second address order, a plurality of addresses simultaneously supplied to the plurality of storage elements in a cycle are identical to each other.

5. The signal processing apparatus according to claim 4, wherein the operation processing part includes:
a butterfly operation processing circuit configured to perform butterfly operation processing on the plurality of pieces of data; and
a twiddle factor multiplication processing circuit configured to multiply the plurality of pieces of data by corresponding twiddle factors, and
wherein the storage processing part further includes:
a first conversion circuit;
a first data distribution circuit;
a second data distribution circuit; and
a second conversion circuit,
wherein the first conversion circuit is configured to:
receive a plurality of pieces of data represented in the two's complement representation; and
convert the received plurality of pieces of data represented in the two's complement representation to a plurality of pieces of data represented in the second representation format for output,
wherein the first data distribution circuit is configured to:
receive the plurality of pieces of data represented in the second representation format outputted from the first conversion circuit; and
perform data distribution processing of the received plurality of pieces of data for output, the plurality of pieces of data represented in the second representation format distributed and outputted by the first data distribution circuit being written to the plurality of storage elements using addresses outputted from the first control circuit,
wherein the second data distribution circuit is configured to:
receive the plurality of pieces of data represented in the second representation format read from the plurality of storage elements using addresses outputted from the second control circuit; and
perform data distribution processing of the received plurality of pieces of data for output, and
wherein the second conversion circuit is configured to:
receive the plurality of pieces of data represented in the second representation format distributed and outputted by the second data distribution circuit; and
convert the received plurality of pieces of data represented in the second representation format to a plurality of pieces of data represented in the two's complement representation.

6. A signal processing apparatus, performing (n×n)-point fast Fourier transform or inverse fast Fourier transform, the signal processing apparatus comprising:
first to third data reordering processing circuits;
first and second butterfly operation processing circuits; and
a twiddle factor multiplication processing circuit that multiplies data by a twiddle factor,
wherein the first data reordering processing circuit is configured to:
receive n pieces of data supplied in parallel in a sequential order, for n cycles (n is a predetermined integer not less than 2),
rearrange an order of the n pieces of data to a bit-reversed order; and
output in parallel the n pieces of data rearranged to the bit-reversed order, for n cycles,
wherein the first butterfly operation processing circuit is configured to:
perform a butterfly operation on the n pieces of data outputted in parallel by the first data reordering processing circuit; and
output in parallel n pieces of data subjected to the butterfly operation,
wherein the second data reordering processing circuit is configured to:
receive the n pieces of data outputted in parallel in a sequential order by the first butterfly operation processing circuit for n cycles; and
rearrange an order of the n pieces of data to the bit-reversed order; and outputs in parallel the n pieces of data rearranged to the bit-reversed order for n cycles,
wherein the twiddle factor multiplication processing circuit is configured to
multiply the n pieces of data outputted by the second data reordering processing circuit by corresponding twiddle factors to output resulting n pieces of data,
wherein the second butterfly operation processing circuit is configured to:
perform a butterfly operation on the n pieces of data outputted by the twiddle factor multiplication processing circuit; and
output the n pieces of data subjected to the butterfly operation,
wherein the third data reordering processing circuit is configured to:
receive the n pieces of data outputted in the bit-reversed order by the second butterfly operation processing circuit for the n cycles,
rearrange an order of the n pieces of data to the sequential order; and output in parallel the n pieces of data rearranged to the sequential order, for n cycles,
wherein the first and the second butterfly operation processing circuits and the twiddle factor multiplication processing circuit perform operation processing on the n pieces of data, each represented in a two's complement representation as a data representation format, and
the first to the third data reordering processing circuits rearrange an order of the n pieces of data, each represented in a second representation format as a data representation format,
wherein the n pieces of data are each D-bits (where D is a positive integer greater than or equal to three),
the second representation format for a non-negative value of the D-bits data is identical to the two's complement representation therefor, and
the second representation format for a negative value of the D-bits data has a representation format in which (D−N−1) bits of the D-bits data represented in the two's complement representation are bit-wise inverted (where N is a positive integer such that N≤D−2),
wherein the (D−N−1) bits are remaining bits in the D-bits data obtained by excluding a most significant bit indicating a sign and N consecutive lower bits including a least significant bit therefrom.

7. The signal processing apparatus according to claim 6, wherein each of the first to the third data reordering processing circuits includes:
a storage circuit including n storage elements configured to store the n pieces of data, respectively, for each of n cycles;
a first control circuit configured to perform control to write the n pieces of data to the n storage elements, for n cycles, in accordance with one of a first address order and a second address order; and
a second control circuit configured to perform control to read from the n storage elements, in accordance with other of the first address order and the second address order, for n cycles, the n pieces of data written to the n storage elements in accordance with the one of the first address order and the second address order,
wherein in the first address order, n addresses respectively supplied to the n storage elements in a cycle are different from each other, and
in the second address order, the n addresses respectively supplied to the n storage elements in a cycle are identical to each other.

8. The signal processing apparatus according to claim 7, wherein the first and the second control circuits are configured to alternately switch between the first address order and the second address order, every n cycles.

9. The signal processing apparatus according to claim 6, wherein at least one of the first and the second butterfly operation processing circuits and the twiddle factor multiplication processing circuit includes
a lower-bit mask circuit configured to set each of a second number lower bits of data (the second number is at least one and no greater than the first number) to a predetermined fixed value to output resulting data.

10. A signal processing method by a processor and/or a hardware circuit, comprising:
performing operation processing on D-bits data (D is a positive integer greater than or equal to three) represented in a two's complement representation as a data representation format; and
performing storage processing on D-bits data represented in a second representation format as a data representation format,
wherein the second representation format for a non-negative value of the D-bits data is identical to the two's complement representation therefor, and
the second representation format for a negative value of the D-bits data has a representation format in which (D−N−1) bits of the D-bits data represented in the two's complement representation are bit-wise inverted (where N is a positive integer such that N≤D−2), wherein the (D−N−1) bits are remaining bits in the D-bits data obtained by excluding a most significant bit indicating a sign and N consecutive lower bits including a least significant bit therefrom.

11. The signal processing method according to claim 10, further comprising:
setting each of M lower bit or bits in the D-bits data received to a predetermined fixed value, the M lower bit or bits including the least significant bit (M is a positive integer such that 1≤M≤N) for output.

12. The signal processing method according to claim 10, wherein the storage processing includes
rearranging an order of the plurality of pieces of data supplied in a first order to a second order, the plurality of pieces of data each being D-bits, wherein
the rearranging the order of the plurality of pieces of data includes:
writing the plurality of pieces of data in parallel to a storage circuit in accordance with one of a first address order and a second address order; and
reading in parallel from the storage circuit, the plurality of pieces of data that have been written to the storage circuit in accordance with the one of the first address order and the second address order, in accordance with other of the first address order and the second address order.

13. The signal processing method according to claim 12, comprising:
for a plurality of storage elements included in the storage circuit configured to store the plurality of pieces of data, for each of a plurality of cycles,
supplying, in a cycle, a plurality of addresses different from each other simultaneously to the plurality of storage elements in a cycle, in the first address order; and
supplying, in a cycle, a plurality of addresses identical to each other simultaneously to the plurality of storage elements, in the second address order.

14. The signal processing method according to claim 13, wherein the operation processing includes:
performing butterfly operation processing on the plurality of pieces of data; and
performing twiddle factor multiplication processing on the plurality of pieces of data,
wherein the storage processing includes:
first conversion processing including:
receiving a plurality of pieces of data represented in the two's complement representation; and
converting the received plurality of pieces of data represented in the two's complement representation to a plurality of pieces of data represented in the second representation format for output;
first data distribution processing including:
receiving the plurality of pieces of data represented in the second representation format outputted by the first conversion processing; and
performing data distribution processing the plurality of pieces of data represented in the second representation format for output to the plurality of storage elements, the plurality of pieces of data being written to the plurality of storage elements using one of the first address order and the second address order;
second data distribution processing including:
receiving the plurality of pieces of data represented in the second representation format read from the plurality of storage elements using other of the first address order and the second address order; and
performing data distribution processing the plurality of pieces of data represented in the second representation format for output; and
second conversion processing including:
receiving the plurality of pieces of data represented in the second representation format distributed and outputted by the second data distribution processing; and
converting the plurality of pieces of data represented in the second representation format to the plurality of pieces of data represented in the two's complement representation for output.
